(19) United States
(12) Patent Application Publication
(10) Pub. No.: US 2019/0141013 A1
(43) Pub. Date: May 9, 2019

(54) METHOD AND SYSTEM FOR INFORMATIONAL CONTENT QUALITY VERIFICATION

(71) Applicant: ADJESTY SOFWARE LTD., Zur lgal (IL)

(72) Inventor: David MAIL, Zur igal (IL)

(21) Appl. No.: 16/306,603

(22) PCT Filed: Jun. 4, 2017
(86) PCT No.: PCT/IL2017/050620

§ 371 Date: Dec. 3, 2018

Related U.S. Application Data
(60) Provisional application No. 62/344,418, filed on Jun. 2, 2016.

(51) Int. Cl. H04L 29/06; G06F 16/908; H04L 29/08

(52) U.S. Cl. CPC H04L 63/0236; H04L 67/02; G06F 16/908; H04L 63/0263

(57) ABSTRACT

A method and system for verifying informational content, such as digital advertisements, uses two interconnected flows, an online flow and an offline flow. When the system determines the online flow is to be applied to the informational content, the informational content was previously analyzed by the system. When the system determines the offline flow is to be applied, the informational content has not been analyzed, processed, or otherwise handled by the system previously. Once both online and offline analyses are complete, the system transmits the informational content to a destination, such as an exchange platform.

### CROSS-REFERENCES TO RELATED APPLICATIONS

This application is related to and claims priority from commonly owned U.S. Provisional Patent Application Ser. No. 62/344,418, entitled: METHOD AND SYSTEM FOR ADVERTISEMENT QUALITY VERIFICATION, filed on Jun. 2, 2016, the disclosure of which is incorporated by reference in its entirety herein.

### FIELD OF THE INVENTION

The present invention relates to digital information, such as advertisement technologies, and more particularly to techniques for evaluating digital advertisements and digital advertising campaigns.

### BACKGROUND OF THE INVENTION

As digital content providing, including information such as advertising, continues to grow, publishers are increasingly aware of the need to protect their audiences from malvertising, illegal or offensive content, pushed downloads and automatic redirects that lead to attacks on their websites and through their mobile applications. Historically, Publishers tried to avoid “bad ads” by closing one-on-one guaranteed deals with premium demand partners. However, this method is not scalable for the fast growing advertisement market, and does not allow Publishers to enjoy the advantages of programmatic media buying when an impression opportunity in their inventory is offered for sale to multiple buyers in real time. As programmatic media buying continues to grow in order to satisfy yield optimization, the risk of poor and unacceptable campaign quality arises, putting Publishers' brands and goodwill at risk.

Established content providers, including those who provide advertising content, such as Google®, have policies, such as for their Ad Words® content (See, Google Ad Words policies: https://support.google.com/adwordspolicy/answer/6008942?hl=en, and Official Google Blog: How we fought bad ads in 2015: https://googleblog.blogspot.co.il/2016/01/better-ads-report.html) This prohibits many products and services from being advertised via Google's network (e.g., “recreational drugs”, “tobacco products” or “academic cheating services”). However, less established advertising providers may still accept these well-paying campaigns. Furthermore, the programmatic chains of ads delivery can comprise multiple advertising providers who are unaware of content of the creative and/or the campaign' landing page and cannot distinguish between “good” and “bad” ads. Also the definition of a “bad” ad or campaign is subjective, and advertisements that are accepted by one publisher may not be accepted by another publisher.

IAB, in its report, “What is an untrustworthy supply chain costing the US digital advertising industry?” at http://www.iab.com/wp-content/uploads/2015/11/IAB_EY_Report.pdf, estimated that the total cost impact of an untrustworthy supply chain in digital advertising is approximately $8.2B in 2015 in the US alone. Of this amount, S1.1B goes to malvertising activities. As per International Advertising Bureau (IAB) UK research “22% [of UK media agencies] have ‘no idea’ about brand safety on mobile”, as reported at http://www.iabuk.net/about/press/archive/brand-safety-mobile-privacy-top-challenges-for-mobile-industry. The same research concludes that “mobile programmatic, brand safety and mobile privacy are topics of concern for media agencies” and defines that the brand safety and the mobile privacy are the top challenges in mobile advertising.

### SUMMARY OF THE INVENTION

The invention is related to programmatic advertising, specifically to brand protection and life time value optimization for the properties and the entities that belong to the Supply side of the advertising ecosystem. These supply side entities include, for example, mobile, tablet computer, desktop computer and television publishers, their digital properties and their customers, Mediation and Optimization Platforms for Publishers, SSPs, Advertising (Ad) Exchanges, Ad Networks, Header Bidding services, and content recommendation systems, including affiliate networks.

Embodiments of the present invention disclose methods and systems for advertisement campaigns categorization, advertisement quality verification and publishers' brand protection, which is designed to address advertisement creative quality and the quality of advertisement campaigns, by allowing real time control of programmatic workflow and by providing full transparency for the advertising content. Using the present invention, the Publisher or any entity acting on behalf of the Publisher (e.g. SSP (Supply Side Provider), Header Bidding solution or Ad (Advertisement including information) Exchange), can control the ad quality in one or multiple inventories, such as a specific ad placement on a web site or inside a mobile app, and request the Exchange, Mediation platform or a SSP to select ads according to its brand policies, so only the matching ads are selected for a certain inventory.

Embodiments of the present invention may include two interconnected flows: an online flow and an offline flow. The online flow is designed to deliver fast replies (a few tens of milliseconds or less) carrying information about each specific ad or campaign. The online flow may participate in the real time programmatic delivery of the advertisement, e.g., a real time (RTB) auction or a mediation solution, or when used in the header bidding, or in the “waterfall” ads selection. In the online flow, all of the responses (e.g., bids) received from demand partners/advertisers are verified in real time, as compared to a fast real time database, which may store, e.g., categorized campaigns and ad information, along with other data, associated with this specific advertisement campaign, e.g., direct or processed information entered via system graphic user interface (GUI) about protection and alert rules, or direct block or alert flags associated with this campaign. If this information is found in the database during online flow, then it can be returned to the platform which activated the online flow (e.g., Publisher' mediation platform, header bidding service, a SSP (Supply Side Platform). Ad Network or an Ad Exchange).

Thus, the platform, which activated the online flow, can acquire the knowledge about the campaign and/or an ad creative, and can take into consideration how such a campaign/ad matches the Publisher-defined brand protection criteria for the given inventory. An example of such information provided by the described invention can be information about the campaign safety (e.g., “safety: 80%”), specific categories describing the campaign content (e.g., “category: alcohol”), campaign recommended target audience (e.g., “target_audience: male, 18-25; female, 18-25”) and general matching ratio to the Publisher-defined multiple brand protection criteria (e.g., “total_matching_factor: 20%”). Additionally, the present invention may simply inform the calling platform about an ad or a campaign which, following the system analysis or user actions through the system Graphical user interface (GUI) should not be delivered (e.g., “blocked: yes”). Having this information the calling platform can make a real time programmatic decision whether to select such an ad or a campaign, or if it should prefer another ad/campaign (e.g., another bid in a RTB auction), which has a better matching for the Publisher's definitions e.g. better fits Publisher's brand protection policies or better satisfies other criteria returned by the system of the present invention.

Should the present invention lack knowledge about a certain advertisement, then it sends the ad to the offline flow. In the offline flow various software modules analyze the ad along with additional information contained in the ad request and the demand responses. The information from the campaign's landing page is collected, and the final results are made available for the online flow software modules. The offline flow may also include the analysis of historic data, of the mediation chain, of the advertising domain, and of the request information.

Embodiments of the present invention may also be implemented as a platform which analyses the information about ads and campaigns without the modules responsible, on providing real time information during the ad request. Such a system is typically used for issuing reports on ad quality, and can be used for providing near real time alerts (e.g., by email), or by issuing HTTP (Hypertext Transfer Protocol) “callback” requests to the platform, on campaigns and ads that do not match the predefined brand policies criteria, as well as for sending periodic (e.g., daily) reports about ad quality. Such a system can also be used to report information in “near real time”, i.e. as fast as it is discovered, to a third party system, e.g. a backend system of an Ad Network, so the Ad Network can make either programmatic or human-initiated decisions, or both about further actions associated with the reported ad campaign, e.g. closing such a campaign or marking it as “never should be selected as a winning bid”.

In addition, various platforms such as SSPs, Exchanges and Ad Networks may use current invention as a visualization tool for their customers, showing up their inventories for their Demand partners as well as showing up what ads run in each inventory for their Publishers. This visualization provided by current invention may include sophisticated business analytics, e.g., frequency, pricing, inventory and informational campaigns, including ad campaigns, categories and other important parameters that can be used by the platforms' owners and their partners and customers who have access to this system for making important business decisions.

Embodiments of the present invention are directed to methods and systems for verifying informational content, such as digital advertisements, which uses two interconnected flows, an online flow and an offline flow. When the system determines the online flow is to be applied to the informational content, the informational content data associated with the informational content is transmitted to a destination, such as an exchange, e.g., advertising exchange, platform. When the system determines the offline flow is to be applied, for example, as this informational content has not been analyzed, processed, or otherwise handled by the system previously, the informational content is analyzed to determine characteristics of the informational content, before transmitting the data associated with the informational content to a destination, such as the exchange platform.

Embodiments of the present invention are directed to methods and systems for verifying informational content, such as digital advertisements, uses two interconnected flows, an online flow and an offline flow. When the system determines the online flow is to be applied to the informational content, the informational content was previously analyzed by the system. When the system determines the offline flow is to be applied, the informational content has not been analyzed, processed, or otherwise handled by the system previously. Once both online and offline analyses are complete, the system transmits the informational content to a destination, such as an exchange platform.

Embodiments of the present invention are directed to a method for verifying informational content. The method comprises: receiving informational content; assigning a key including a unique identifier for the informational content; and, determining whether the key for the informational content exists; and, if the key exists, transmitting data associated with the informational content to a first predetermined destination; and, if the key does not exist, analyzing the informational content in a virtual environment to determine characteristics of the informational content, before transmitting the data associated with the informational content to a second predetermined destination.

Optionally, the first predetermined destination and the second predetermined destination are the same destination.

Optionally, the first predetermined destination and the second predetermined destination are different destinations.

Optionally, the key additionally includes data associated with a request for the informational content from a source over a communications network.

Optionally, the data associated with the informational content includes metadata, and the first and second predetermined destinations include a computerized platform.

Optionally, the computerized platform functions as an exchange.

Optionally, the receiving the informational content includes receiving a plurality of informational content in response to a request for at least one informational content from a source, each of the informational content received from a demand partner over the communications network, and the computerized platform analyzing the metadata associated with each of the visual items to select at least one of the informational contents to satisfy the request for at least one informational content from the source.

Optionally, the determining whether the key for the informational content exists includes comparing the key to at least one key in a storage media for a correspondence including matching keys.

Optionally, the analyzing the informational content in a virtual environment to determine characteristics of the informational content includes building the informational content and modeling the built informational content.

Optionally, the modeling the built informational content includes: analyzing the built informational content; analyzing a click path from the built informational content to a landing page of a destination; analyzing the landing page; and, analyzing the domain of the landing page.

Optionally, the modeling the built informational content additionally comprises: assigning a score to the informational content.

Optionally, the analyzing the built informational content includes: determining a category for the informational content from the visual and textual content of the informational content; and, analyzing the visual and textual content of the built informational content against rules for the textual and visual content for informational content.

Optionally, the rules include requirements for at least a privacy policy and links to destinations of certain categories and content.

Optionally, the method additionally comprises: applying at least one rule to the category to determine whether the informational content should be blocked.

Optionally, the analyzing the click path includes verifying that all links are operable and direct to existing destinations web pages which are valid.

Optionally, the analyzing the landing page includes: determining a category for the informational content from the visual and textual content of the landing page; and, analyzing the visual and textual content of the landing page against rules for the textual and visual content.

Optionally, the analyzing the domain of the landing page includes at least one of: determining whether the domain is on a whitelist or a blacklist; and, determining the quality of the domain including basing the quality on a reputation of the domain.

Optionally, the informational content includes at least one of: a creative, a banner, and an electronic graphic, which is click linked to a destination along the communications network.

Optionally, the request data includes one or more of source location, source operating system, and source device type.

Optionally, the informational content includes visual media items, which include one or more of: graphics, text, and click links.

Optionally, the visual media items include one or more of: banners, creatives, pop overs, pop behinds, scrolls, and video clips.

Optionally, the receiving the informational content includes: receiving the informational content as filtered from a Hypertext Transfer Protocol (HTTP) response to an HTTP request.

Embodiments of the present invention are directed to a system for verifying informational content. The system comprises: a storage medium for storing computer components; and, a processor for executing the computer components. The computer components comprise: a first computer component configured to assign a key including a unique identifier for the informational content; and, a second computer component configured to determine whether the key for the informational content exists; and, if the key exists, transmitting data associated with the informational content to a first predetermined destination; and, if the key does not exist, analyzing the informational content in a virtual environment to determine characteristics of the informational content, before transmitting the data associated with the informational content to a second predetermined destination.

Optionally, the system additionally comprises: a third computer component configured to determine whether the key for the informational content exists, by comparing the key to at least one key in a storage media for a correspondence including matching keys.

Optionally, the system additionally comprises: a fourth computer component configured to build the informational content and modeling the built informational content, for analyzing the informational content in the virtual environment.

Optionally, the system is such that the modeling of the built informational content includes: analyzing the built informational content; analyzing a click path from the built informational content to a landing page of a destination; analyzing the landing page; and, analyzing the domain of the landing page.

Optionally, the system is such that the modeling the built informational content additionally comprises: assigning a score to the informational content.

Optionally, the system additionally comprises: a fifth computer component configured for analyzing the built informational content by processes including: determining a category for the informational content from the visual and textual content of the informational content; and, analyzing the visual and textual content of the built informational content against rules for the textual and visual content for informational content.

Optionally, the system is such that the rules include requirements for at least a privacy policy and links to destinations of certain categories and content.

Optionally, the system is such that the fifth computer component is additionally configured to: apply at least one rule to the category to determine whether the informational content should be blocked.

Optionally, the system additionally comprises: an explorer module in communication with the second computer component, the explorer module configured to analyze the click path, including verifying that all links are operable and direct to existing destination web pages which are valid.

Optionally, the system additionally comprises a landing page module in communication with the second computer component configured to: determine a category for the informational content from the visual and textual content of the landing page; and, analyze the visual and textual content of the landing page against rules for the textual and visual content.

Optionally, the system additionally comprises a landing page domain analysis module in communication with the second computer component configured to: analyze the domain of the landing page by at least one of: determining whether the domain is on a whitelist or a blacklist; and, determining the quality of the domain based on a reputation of the domain.

Optionally, the system additionally comprises: a filtration module in communication with the first computer component, the filtration module configured for: filtering the informational content from a Hypertext Transfer Protocol (HTTP) response to an HTTP request, and transmitting the informational content as filtered to the first computer component.

Embodiments of the present invention are directed to a computer usable non-transitory storage medium having a computer program embodied thereon for causing a suitable programmed system to verify informational content, by performing the following steps when such program is executed on the system. The steps comprise: receiving informational content; assigning a key including a unique identifier for the informational content; and, determining whether the key for the informational content exists; and, if the key exists, transmitting data associated with the informational content to a first predetermined destination; and, if the key does not exist, analyzing the informational content in a virtual environment to determine characteristics of the informational content, before transmitting the data associated with the informational content to a second predetermined destination.

Optionally, the computer usable non-transitory storage medium is such that the key additionally includes data associated with a request for the informational content from a source over a communications network.

Optionally, the computer usable non-transitory storage medium is such that the informational content includes at least one of: a creative, a banner, and an electronic graphic, which is click linked to a destination along the communications network.

Optionally, the computer usable non-transitory storage medium is such that the request data includes one or more of source location, source operating system, and source device type.

Optionally, the computer usable non-transitory storage medium is such that the informational content includes visual media items, which include one or more of: graphics, text, and click links.

Optionally, the computer usable non-transitory storage medium is such that the visual media items include one or more of: banners, creatives, pop overs, pop behinds, scrolls, and video clips.

This document references terms that are used consistently or interchangeably herein. These terms, including variations thereof, are as follows.

A “Publisher” is a person or entity having certain digital properties: web sites, mobile or desktop applications, TV applications, media channels, media programs, or digital billboards. The Publisher dedicated part of her digital properties for advertising. This part of Publisher' digital properties is called “inventory”.

An “Advertiser” is a person or a company who is willing to advertise certain products or services. The Advertiser typically looks for a certain inventory and certain audience most matching his advertised message.

An “inventory” is a specific location in a mobile application, on a web site or a television broadcast, where the advertisement is displayed or intended to be displayed. Inventory is also interchangeably referred in the industry as “ad slot” or “ad spot”. Static inventories are pre-defined locations in app or on web, such as a web page header or footer, while dynamic inventories are built on the fly, typically as a part of the web or mobile application response on the user action, e.g. on scrolling down content page. For instance, Native Advertising is typically served via dynamic inventories.

An “Ad (Advertisement) Exchange” (Exchange) and “Ad (Advertisement) Network) are technology platforms that facilitate the buying and selling of media advertising inventory from multiple sources.

“Supply Side Platform (SSP)” is a technology platform which helps Publishers to manage their inventory.

“Demand Side Platform (DSP)” is a technology platform which helps Advertisers to programmatically buy inventory via multiple Ad Exchanges.

An “API (Application Programming Interface)” is a set of routines, protocols, and tools for accessing certain functionality and/or building software solutions that utilize this functionality.

The terms “click”, “clicks”, “click on”, “clicks on”, “activates”, and “activation”, involves the activation of a computer pointing apparatus, such as a device commonly known as a mouse, or a touch, swipe, contact, or the like on a touch screen, on a location on a computer screen display, including screen displays of tablets and mobile devices, such as smartphones, tablets, iPads®, and the like.

Throughout this document, a “web site” is a related collection of World Wide Web (WWW) files that includes a beginning file or “web page” called a home page, and typically, additional files or “web pages.” The term “web site” is used collectively to include “web site” and “web page(s).”

A uniform resource locator (URL) is the unique address for a file, such as a web site or a web page, including a landing page for an advertising campaign, that is accessible over communication networks including the Internet.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1A is a diagram of an environment for the system in accordance with embodiments of the present invention;

FIGS. 1B and 1C are diagrams of a general real time system architecture with both online and offline flows, constructed and operative in accordance with embodiments of the present invention;

FIG. 2 is a diagram of a system architecture with periodic data loading and periodic reporting, constructed and operative in accordance with a preferred embodiment of the present invention;

FIGS. 3A and 3B are diagrams of an integration schema, constructed and operative in accordance with embodiments of the present invention;

FIG. 4 is a diagram of architecture for testing the outgoing ads in accordance with embodiments of the present invention;

FIG. 5 is a flow diagram for real time reception of advertising (ad) campaign information in accordance with embodiments of the present invention;

FIG. 6 is a diagram of an exploring module in accordance with embodiments of the present invention;

FIG. 7 is a diagram for real time digital ad fraud detection and viewability verification in accordance with embodiments of the present invention;

FIGS. 8A-8L are screen diagrams showing the invention at various stages of operation.

FIG. 9 is a diagram of a real time advertisement verifications using proxy in accordance with embodiments of the present invention;

FIG. 10 is a simplified overview of a typical advertising ecosystem in accordance with embodiments of the present invention; and,

FIG. 11 is a diagram of an example advertisement traffic validation by the communication network or by an internet services provider (ISP) in accordance with embodiments of the present invention.

### DETAILED DESCRIPTION OF THE INVENTION

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more non-transitory computer readable (storage) medium(s) having computer readable program code embodied thereon.

Using the present invention, a publisher or an entity, which acts on behalf of the Publisher (e.g., SSP, Mediation Platform, a company operating a Header Bidding service or an Exchange), may select certain informational campaigns, such as advertising campaigns, that do not fit the Publisher's brand strategy, and request the platform, which communicates with the disclosed home server/system of the present invention to block this campaign from being delivered to the Publishers' inventories. Taking in account these preferences, the platform (e.g., Exchange, SSP) integrated with the disclosed home server/system of the present invention may prefer to select and deliver another, typically a brand-safe advertisements (ads) that match Publisher-defined ads quality criteria. Thus, using the present invention the Publisher can control other remote platforms in the advertising ecosystem, informing them about preferred and/or not allowed types of ads and campaigns for her inventory, on a “per inventory” base. Multiple systems in the ads delivery chain can now programmatically adopt as per the Publisher advertising preferences and requirements, and can select and deliver only matching advertisement as per the Publisher-defined brand protection and inventory matching policies.

The present invention may also be used for investigation of the advertisers spend and competitive analytics for the advertisers. The information collected by the system provides valuable insights on what campaigns are running presently, what is their spend, and what inventory was programmatically bought to run these campaigns. This information can be used by advertisers when planning or adjusting their media buying budgets. Thus the product which incorporates the present invention can be of interest to both the Supply side entities (e.g. Publishers, SSPs, Mediation Platforms, Exchanges, Networks) and the Demand side entities (e.g. Trading Desks, Agencies, Advertisers, DSPs).

The present invention is specifically designed to address inventory protection challenges associated with programmatic ad delivery chains. The present invention defines a new method of delivering digital ads as per inventory-specific criteria, thus allowing Publishers to protect their inventory from ads and campaigns that do not fit their brand policies. The present invention describes a system which can help Publishers or other entities acting on behalf of the Publisher (e.g., SSPs, Exchanges, Mediation Platforms) to better protect their digital properties by defining multiple ads and campaigns matching criteria for each inventory they own. Defining brand policy criteria for any inventory Publisher may take in account multiple parameters, such as specific ad slot locations in the app or site, time of the day, information about the customer (e.g., age, gender) and about the current device (e.g., geo location, operating system) and similar. Multiple platforms involved in the ad delivery can use present invention in order to learn the Publisher's preferences and thus, select the most suitable ads for their inventory.

In addition, the present invention can be used for testing informational content and informational campaigns, such as advertisements and advertising campaigns, should an informational content or advertisement have been modified during its delivery (e.g., by an Advertising or Advertisement (both known as “Ad”) Exchange, while adding tracking events), and for providing the information about the informational content or ad spend, campaign frequency, Demand Side Partner (DSP) spend visualization, and other useful insights that may be used for business and competitive analytics in advertising.

The present invention can also be used by Network Operators (like Verizon, AT&T, Comcast), including Mobile Network Operators (MNO) (e.g., Vodafone) to scan the entire traffic stream coming through their networks and filter out or replace improper informational content, e.g. ads or web landing pages containing viruses or malware. This way the present invention protects the entire communication stream of a Network Provider.

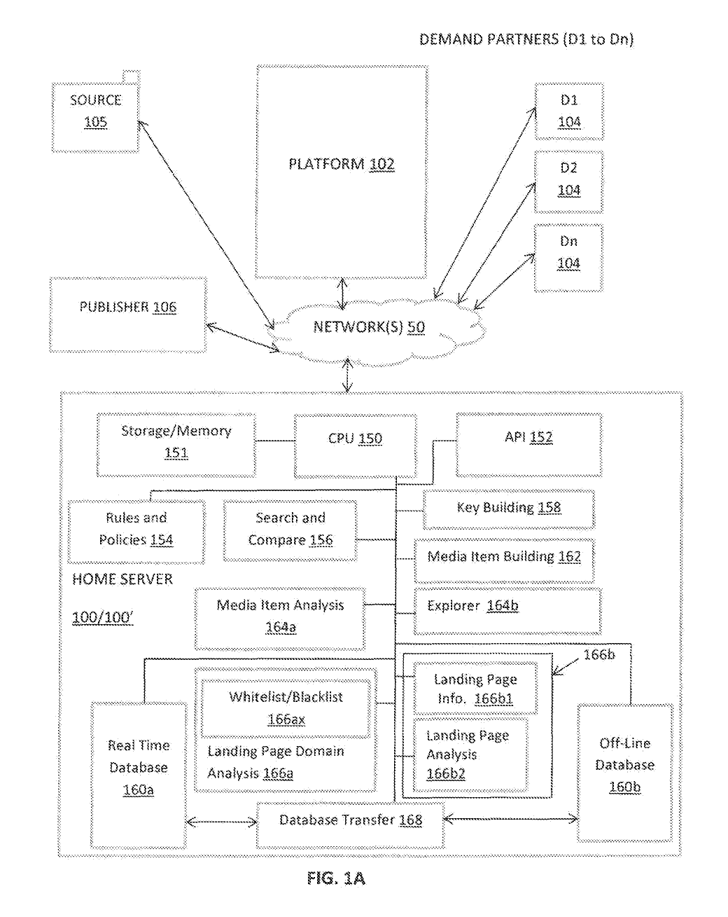

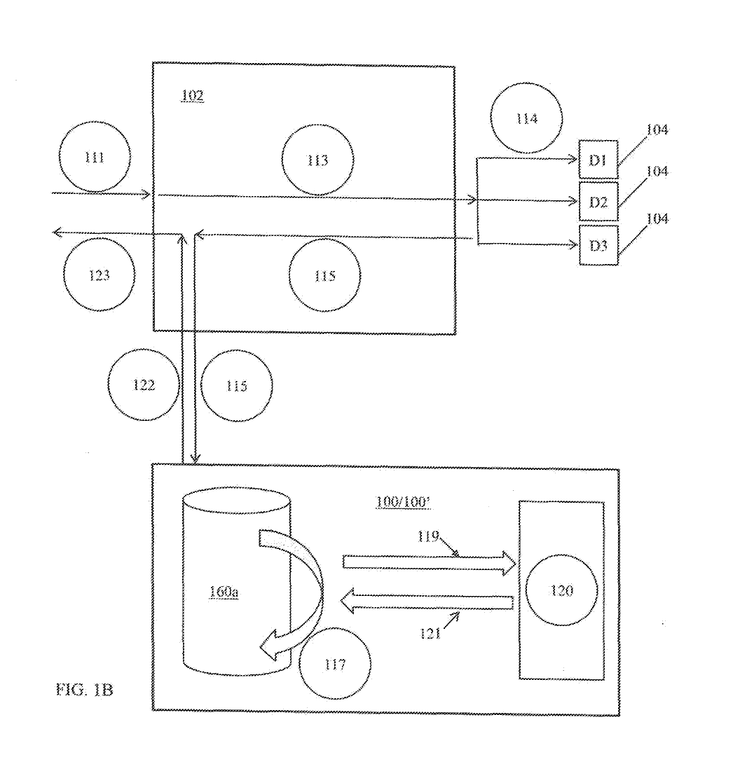

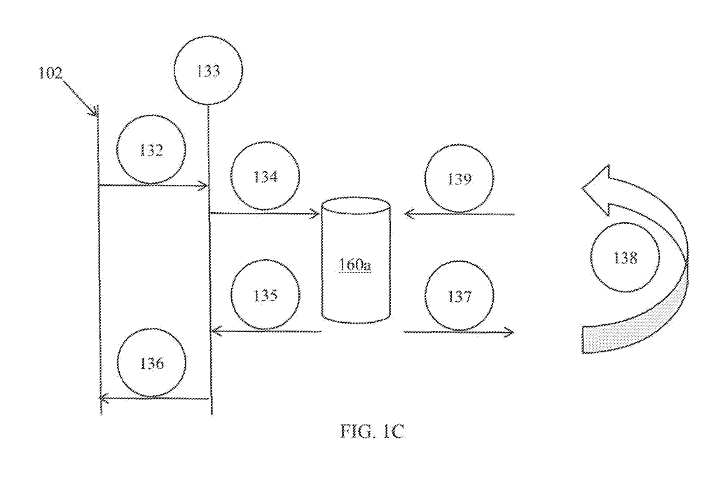

Reference is now made to FIG. 1A, which shows an exemplary environment for the invention. This figure is, for example, a diagram of an environment for real time information providing, categorizing and/or validating for example, in the form of informational content and/or data therefor and/or associated therewith, for example, as digital advertisements (advertisement (ad) content). (Throughout this document, the term “advertisement” and its shortened term “ad”, both singular and plural are used interchangeably herein.) The aforementioned informational content, referred to hereinafter as “informational content”, includes and presents (e.g., displays on display screens of mobile devices, computers and the like) as media items, for example, graphical or visual media items, which typically include graphics (e.g., graphical (visual) elements with graphical content or substance) and text (e.g., textual elements with textual content or substance). These media items/visual media items are, for example, banners, creatives, pop overs, pop behinds, scrolls, video clips, electronic and digital graphics (which are, for example, click linked to a destination along the communications network), and other items, which are, for example, stored, transmitted and rendered in forms, such as computerized data. These banners, creatives, pop overs, pop behinds, scrolls, video clips, and other items are suitable for filling or otherwise occupying spots in display content, as rendered into the display content. (The display content is rendered to mobile devices, computers, televisions and the like, for example, by publishers, such as CNN, the New York Times, and the like.) The informational content, in addition to a graphical element (and data therefor), for example, typically includes click links, such that when displayed as a media item, and the media item, as presented via a display screen, is activated, such as by a click, contact or swipe on a touch screen display, or other activation thereon, the device's or computer's browsing application is directed to the destination, e.g., web page, landing page (typically also a web page) associated with a URL, to which the click link is mapped thereto. The informational content is associated with information and informational campaigns, such as advertising, advertisements (ads), advertising campaigns, and the like. The informational content, for example, ads and/or advertisement campaigns, are categorized and validated in accordance with embodiments of the present invention.

The environment includes a home server 100, also known as a main server, which is linked to a server 102 representing a platform (hereinafter, indicated as platform 102), via one or more communications network(s) 50. The communications network(s) 50 are, for example, communications networks, such as Local Area Networks (LANs), or a Wide Area Networks (WANs), including public networks such as the Internet, as well as cellular networks. “Linked” as used herein includes both wired or wireless links, either direct or indirect, and placing the computers, including, servers, components and the like, in electronic and/or data communications with each other.

Both the home server 100 and the platform 102, link to: 1) demand partners (D1-Dn), represented by servers 104 (hereinafter Demand Partners D1-Dn 104), 2) a source 105 representative of numerous sources, the source 105, for example, a computer device, such as a mobile device including smartphones, tablet and laptop computers, including iPads®, personal computers, and other computers and computerized devices, via the communications network(s) 50, and publishers, represented by the server 106, via the communications network(s) 50. Also, all of the servers 100, 102, 104, 106 and the source 105, are linked to each other via the communications network(s) 50.

The platform 102 is, for example, an Advertising Exchange, SSP (Supply Side Platform), Header Bidding service or a mediation platform, in one or more servers, computers, computerized components and the like, shown as a server 102 (hereinafter, “platform 102”), linked to the communications network(s) 50. The platform 102 functions to receive content requests, either direct, including information or advertisement requests, one or more, from sources (represented by the source 105), or indirect sources, such as other SSPs, Information/Ad networks and exchanges, over the communications network(s) 50.

The demand partners D1-Dn 104, are, for example, linked to the communications network(s) 50. These demand partners D1-Dn 104 provide informational content, for example, as digital advertisements (advertisement content).

The source 105, for example, includes content from a publisher (represented by a server 106, which is linked to the network(s) 50, hereinafter indicated as publisher 106), such as a web site or a mobile application (app), the content (e.g., display content) displaying on a display, i.e., display screen (touch screen, monitor, or other visible display) of the source 105 device, as display content, e.g., a web page from CNN. The display content, for example, includes spots for supporting informational content, as examined by the system 100′ and rendered into the requisite spots of the display content.

The requests (from the source 105), also known as content requests, or, informational content requests, including advertisement (advertisement content) requests, are sent to the platform 102, which selects demand partners 104 to fulfill the request, with media items. The demand partners 104 respond to the requests by sending informational content to the platform 102. The platform 102 then sends informational content to the home server 100. The home server 100 analyzes the informational content and passes it to the platform 102. This passing of the informational content back to the platform 102 from the home server 100, is typically additionally subject to rules and policies, for example, no gambling, no adult content, only English language informational content.

The platform 102 then selects one or more media items to fulfill the content request, e.g., informational content request, including an advertisement (advertisement content) request, and which will fit within the spots in the publisher's display content or media, on the display, i.e., display screen (touch screen, monitor, or other visible display), of the source 105. The home server 100 then transmits (sends) the data for displaying the selected informational content within the media item spots on the display screen of the source 105, to the platform 102, which transmits the informational content to the source. The informational content, as detailed above, is for example, a visual media item (or items should there be more than one spot in the display content) that is click linked (linked) to one or more destinations (in succession if more than one destination), such as web pages, including landing pages, along the communications network(s) 50.

The home server 100, which although shown as a single server, may be one or more servers, computers, computer devices and the like. The home server 100 includes computer components (components) for performing the invention, which form a system 100′. The computer components include, for example, a central processing unit (CPU) and storage/memory 151 for the CPU 150. Other computer components, which are, for example, controlled by the CPU 150, and are in direct or indirect communication with the CPU 150 and each other, include, for example, an application programming interface (API) 152, rules and policies module 154, a search and compare module 156, a key building module 158, a real time database 160a, an off-line database 160b, a media item building module 162, a media item analysis module 164a, an explorer module 164b, a landing page domain analysis module 166a (including whitelists/blacklists 166ax), a landing page module 166b (including a landing page information module 166b1 and landing page analysis module 166b2) and a database transfer module 168.

The Central Processing Unit (CPU) 150 is formed of one or more processors, including data processors, microprocessors, and the like for performing the home server 100 and system 100′ functions and operations detailed herein, including controlling the application programming interface (API) 152, the rules and policies module 154, the search and compare module 156, the key building module 158, the real time database 160a, then off-line database 160b, the media item building module 162, the media item analysis module 164a, the explorer module 164b, the landing page domain analysis module 166a, the landing page module 166b, and the database transfer module 168. The processors are, for example, conventional processors, such as those used in servers, computers, and other computerized devices. For example, the processors may include x86 Processors from AMD and Intel, Xenon® and Pentium® processors from Intel, as well as any combinations thereof.

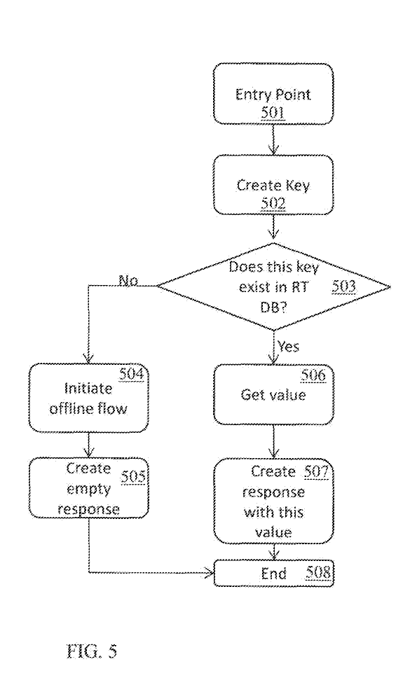

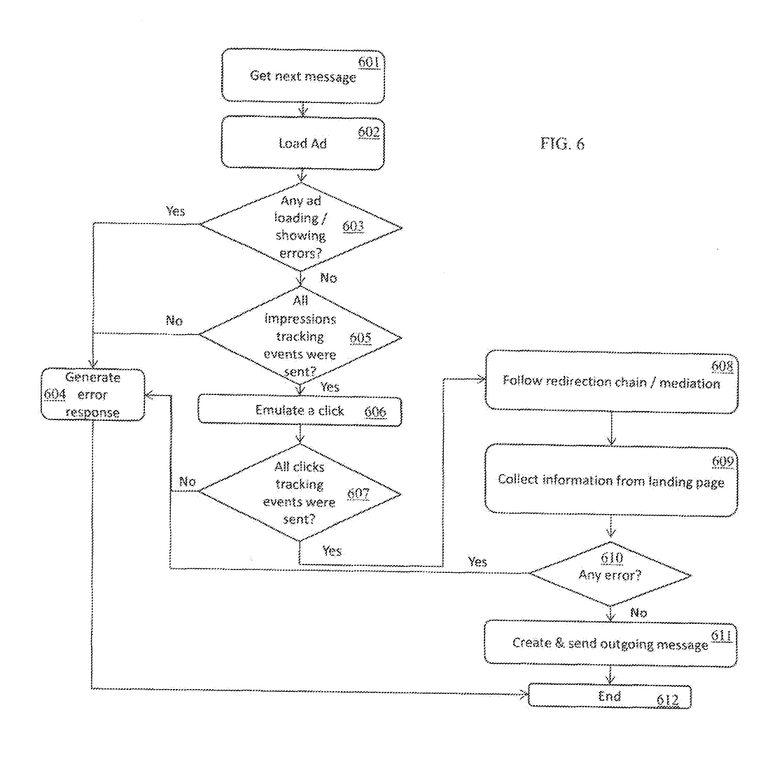

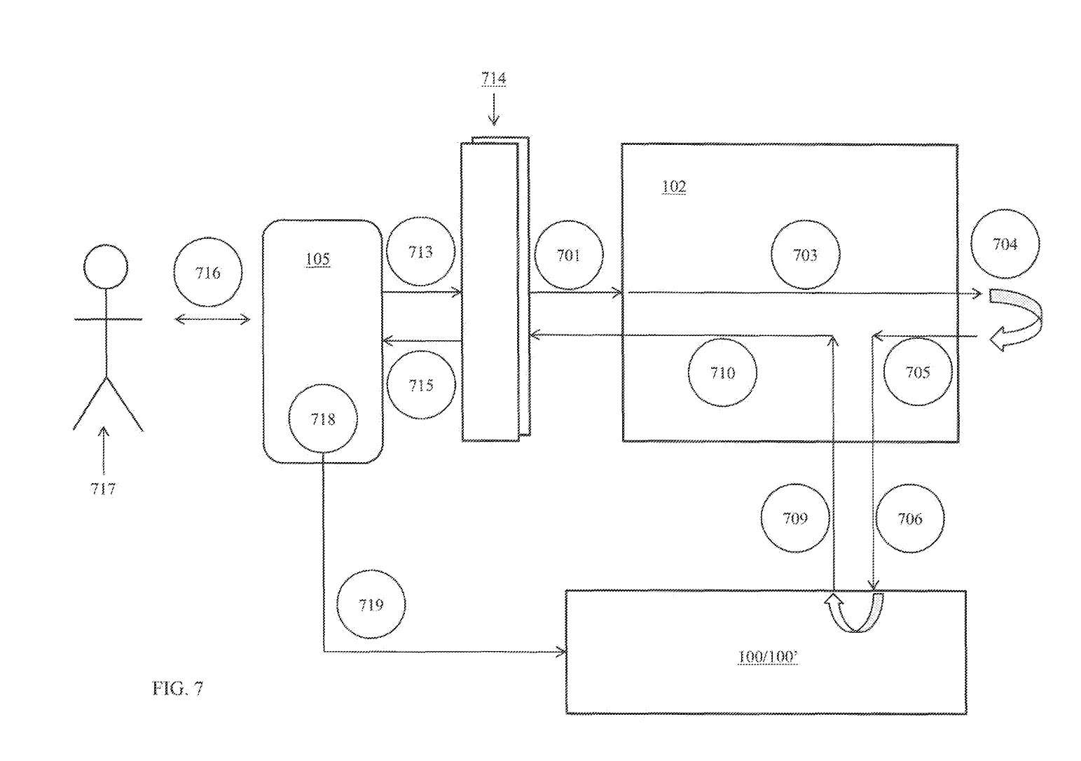

The storage/memory 151 is any conventional storage media. The storage/memory 151 stores machine executable instructions for execution by the CPU 150, to perform the processes of the invention. The storage/memory 151 also includes machine executable instructions associated with the operation of the above listed components, along with the processes and subprocesses shown in FIGS. 5 and 6, detailed herein. The processors of the CPU 150 and the storage/memory 151, although shown as a single component for representative purposes, may be multiple components, and may be outside of the home server 100 and/or the system 100′, and linked to the communications network(s) 50.

The API module 152, for example, functions to access certain functionalities over the communications network(s) 50 and/or building software solutions that utilize these functionalities.

The Rules and Policies module 154 stores rules and policies for the system 100′ and applies these stored rules and policies in the processes of the invention when necessary.

The search and compare module 156 performs searching and comparing analysis. For example, when informational content and/or data from demand partners D1-Dn, 104, via the platform enters the system, and becomes part of a key, the key searched for and compared to other keys stored in the Real Time Database 160a, to determine whether the system 100′ has this key and therefore, has analyzed this informational content and/or data associated therewith, previously.

The key building module 158 takes the informational content and/or the data associated with it, and data associated with requests (request data), as sent from sources 105, if received by the system 100′ and builds, and accordingly, assigns, a key therefrom. This key includes, for example, a unique identifier, associated with the informational content and may also include request data, for example, data associated with the location of the requesting source, the publisher category and content rendered to the requesting source, and the type of device of the requesting source, and the like. This key is then searched for and compared with the keys stored in the real time database 160a for matches or correlations.

The real time database 160a (also known as an online database), and Offline Database 160b, are databases which store informational content and/or data therefor and/or associated therewith. A database transfer module 168 between these databases 160a, 160b, transfers informational content and/or data therefor and/or associated therewith. For example, informational content and/or data therefor and/or associated therewith, which has been processed offline, as shown, for example, in FIGS. 1C and 6, and stored in the offline server 160b, is made into a key (by the key building module 158), with the key passed to the real time database 160a, by the database transfer module 168. This passed key is stored in the real time database 160a (in addition to all of the previously stored keys).

The media item building module 162 is part of the offline processing, and rebuilds or models the informational content received by the system 100′, for example, in a virtual environment. The rebuilt or modeled informational content is analyzed, in the virtual environment, by the media item analysis module 164a, the explorer module 164b, the landing page domain analysis module 166a, and the landing page module 166b, as detailed below.

The media item analysis module 164a analyzes the banners, creatives, video clips and other items, built or modeled by the media item building module for language, categories, the actual content thereof, and the like.

The explorer module 164b, for example, analyzes the click path of the informational content, e.g., rebuilt or modeled banners, creatives, video clips and other items, to determine whether there is a complete path, absent broken links (so as not to find broken informational content or “broken ads”), to web pages, including landing pages, whether the web pages, including the landing pages of the click path are valid, and other functions, as detailed below.

The landing page domain analysis module 166a analyzes domains associated with the landing pages uncovered by the explorer module 164a, upon its evaluating the click links of the built or modeled informational content. The analysis is for example, for domains with good/bad reputations, which may be performed by checking whitelists/blacklists 166ax or other factors, for example, validation of the domain home page, checking if the domain home page exists and if it provides human-viewable content, has a privacy policy link; if the domain has links from the home page to other pages under the same domain, and if the categories of these additional web pages, also analyzed by present invention, do not fall into “bad ads” like malware or viruses.

The landing page module 166b includes modules 166b1 and 166b2 for analysis of each landing page. The landing page information module 166b collects information from each landing page itself, such as visual information, text, and data, and the landing page analysis module 166b2 analyzes this visual information, text, and data, for example, for categories, context, content, and the like.

Turning to FIG. 1B, the platform 102, such as an Advertising Exchange. SSP, Header Bidding service or a mediation platform, receives a content request (request, for example, an informational content request) 11, such as an advertisement request, for example, from a source 105, such as a mobile computer device, for example, a smartphone, tablet computer, iPad®, or other computer or computer device. This request 111 represents a new impression opportunity. The Platform 102 optionally enriches 113 the request 111 and sends this information (i.e., the content request) 114 to its selected demand partners, e.g. D1-D3, 104. Optionally, these requests 113, 114 and responses 115 (from the demand partners 104) can run as a part of real time bidding (RTB) auction. Once the platform 102 receives responses 115 from its demand partners (e.g. D1-D3) 104, it sends these responses 115 to the home server 100. The home server 100 analyzes 117 the information received and if some campaigns were found in the real time database 160a, for example, by matching keys, formed of a unique identifier (ID) for the informational content and optional request data associated with the requesting source, such as location, type of device, then the home server 100 (system 100′) replies 122 to the platform 102 with campaign metadata. The home server 100 may also apply rules and policies, from the rules and policies module 154, to its replies, such replies not in categories such as gambling or adult, or English language only. The platform 102 then either selects the campaign, and accordingly, its informational content, for example, in the form of visual media items, to be returned 123 to the source 105, for placement in the spots for the display of content on the source 105 display screen, or, after analyzing the metadata received from system 100/100′, decides to use another bid response/ad campaign, which has a better match to the given inventory, e.g. because the returned 122 metadata carries blocking request for this campaign.

If the campaign metadata is not presented in the real time database 160a then the information received in 115 is sent 119 for the automated offline processing 120. Once the offline processing 1110 is completed the home server 100 delivers 121 the campaign's metadata including a key for finding this metadata to the real time database 160a, so the next time the same campaign is delivered via call 115 it will be found in process 117 and its metadata will be sent back 122 to the platform 102 with very short latency.

Optionally, the home server 100 could decide to periodically re-categorize and re-validate already handled informational campaigns, such as ad campaigns, e.g. due to a certain timeout expiration. In such a case the campaign will be sent again 119 to offline categorization and validation, also known as off-line flow 120, and the results will be saved 121 in the real time database 160a. Since multiple categorizations of the same campaign can end up with different categories for various reasons, e.g., due to the changes of the campaign' landing page, they are stored in the database separately for each validation performed, connecting between the categorization date and time, campaign ID and set of the detected categories. This structure is important for detection of “cloaked ads”. i.e. cases when a campaign which was originally declared as an advertisement of e.g. a fast food product suddenly turns into a campaign advertising e.g. an alcohol product. Since the present invention, as performed, for example in the home server 100, periodically re-categorizes and re-validates each informational campaign, such as an advertising campaign. It can detect “cloaking advertising” and alert the platform 102 and/or other customers about such a behavior of a certain advertising campaign.

Reference is now made to FIG. 1C, which is a diagram of an exemplary real time system architecture with two interconnected flows: online and offline, in accordance with the present invention. This real time architecture involves, for example, two interconnected flows, an online flow and an offline flow. An external platform, e.g., the platform 102 (e.g., Exchange, SSP or a mediation platform, such as header bidding or other) typically issues a request 132 (e.g., a content request similar to the content request 111, 113, 114 detailed in FIG. 1B above) to the system 100′, via an entry point 133. An example of the entry point 133 is the server 100 API (Application Program Interface) 152, exposed via the server 100 operating certain communication protocol, such as web server or a proxy server, a messaging system such as Apache Kafka, as described in, for example, at http://kafka.apache.org used for the information exchange, or a software library which implements API functionality at the calling platform 102. The system analyzes 134 the incoming request 132. This analysis may include accessing the real time (online) database 160a, and searching for already existing information, e.g., keys with informational content, such as for ads and ad campaigns included in the initial request, e.g., informational content request including an advertisement request 132. If such prior information is found (e.g., as a matching or correlated key), the system 100′ returns the ad and/or data therefor to the calling platform 102 in its response 135, 136. Thus, the initial request 132 is typically served at a very short time, such that the system 100′, may operate in a real-time mode, timely replying with information 136 about ads and ad campaigns. The replay data about the ad campaigns is then sent 139 to the real-time database 160a for storage.

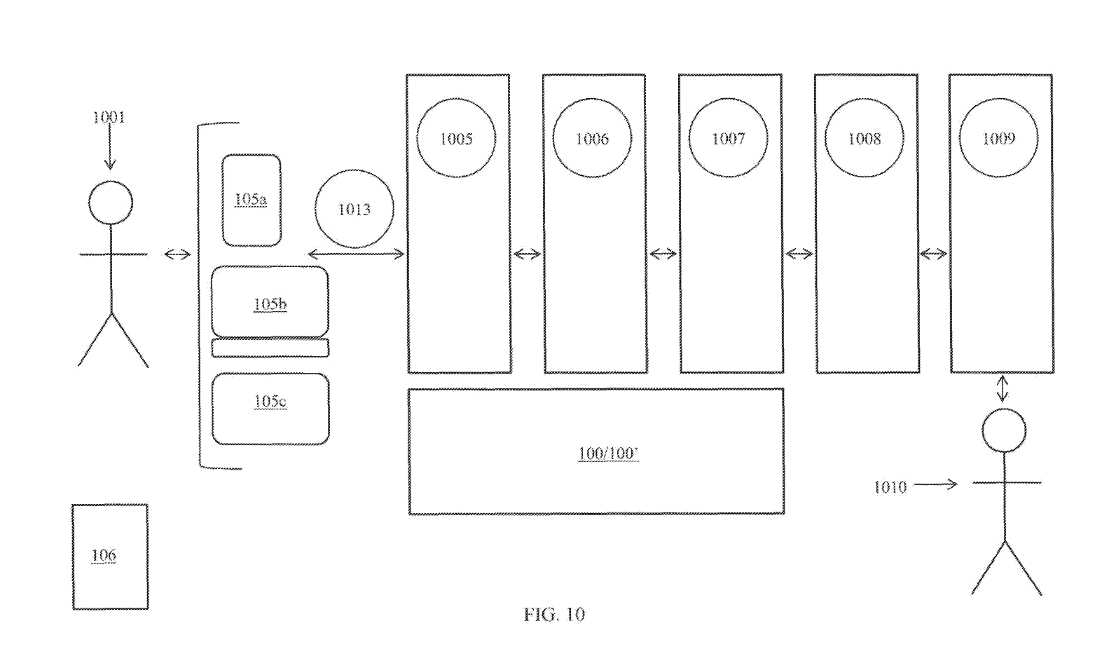

If there is not any information about the ads and/or campaigns provided, or if the stored information is considered by the system 100′, based on the system's 100′ internal criteria, as too old or untimely, the information needs to be refreshed, the system 100′ (also 1005-1009 and 1011 of FIG. 10) may issue an asynchronous request 137, which in turn, initiates the offline flow 138, which is analyzed by modules including, for example, rules and policies module 154, media item building module 162, a media item analysis module 164a, and explorer module 164b, a landing page domain analysis module 166a, and a landing page module 166b.

The offline flow 138 is, for example, used to investigate new informational content, for example, new ads and/or campaigns along with the publisher's inventory, gathering and analyzing the information, for example, in a virtual environment, and storing it 139 in the database 160b. Once the offline flow 138 completes its analysis of the ads and/or ad campaign information, residing in the database 160b, the information is accessed by the above described online flow routines, and is provided 136 to the platform 102. Such information 136 may include, e.g., an indication, whether a campaign was blocked by the Publisher, data about campaign quality, categories, and the like. This information is built into (or otherwise assigned to) a key, by the key building module 158, and passed by the database transfer module 168 to the real time database 160a, where the key for this informational content is stored.

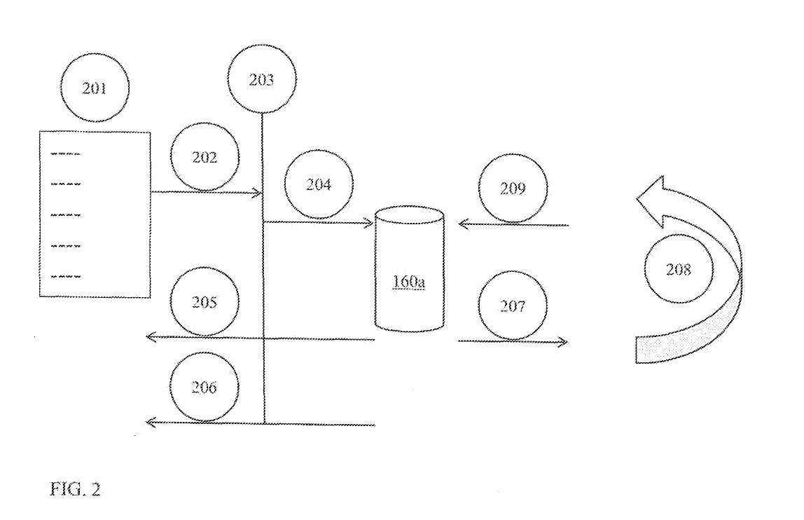

Reference is now made to FIG. 2, which is a diagram of a system architecture (e.g., for the system 100′) with periodic data loading and real time or periodic reporting, constructed and operative in accordance with embodiments of the present invention. This architecture allows the system 100′ to periodically load data and issue real time, near real time and/or periodic reports. This architecture may be used, for example, if the customer is willing to receive information about the ads and campaigns, but may not be willing to integrate their platform with the system 100′.

There is an entry point 201 to access ad information. An example of such an entry point 201 could be system logs, or a messaging system like Apache Kafka, listed above, used to store this information for external access, or a communication server operating via a communication protocol, such as FTP (file transfer protocol) or HTTP/S (hypertext transfer protocol/secured). The system 100′, analyzes 202 information, which comes via entry point 201, and issues a request to entry point 203 of the home server 100. An example of entry point 203 may be a server API 152, exposed via the home server 100 operating certain communication protocol, such as web server or a proxy server, a messaging system such as Apache Kafka, as detailed above, used for the information exchange, or a software library representing API functionality.

The system 100′ analyzes 204 the incoming request. Such an analysis may include accessing the real time (online) database 160a, and searching for already existing information for ads and campaigns included in the initial request 202. If such prior information is found, the present invention may analyze it and make further decisions based on one system-defined criteria. For instance, if configured accordingly, the present invention may decide to send alerts, e.g., email or SMS alerts, to the Publisher 106, or any other entity as per the system 100′ configuration, notifying them about certain events. The alerts may be configured to be sent in real time, as soon as found, or with other timing or bulk preferences. An example of such an alert can be a notification “Alcohol campaign detected!” containing the details of such a found advertising campaign. Having received this notification, the entities involved in the campaign delivery chain can take an action accordingly. In addition, the present invention may send periodic reports 206, that may include all or only certain ads or campaigns, and can be issued for multiple recipients with content customized and relevant for each recipient.

The above described alerts functionality 205 can be included in any system configuration, including the system operating in real time mode, as illustrated in FIG. 1C.

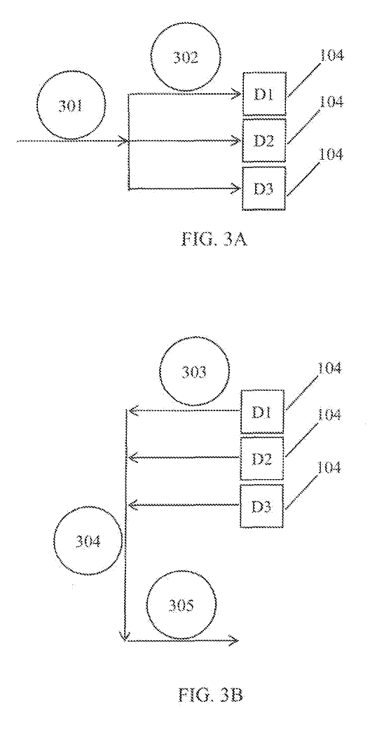

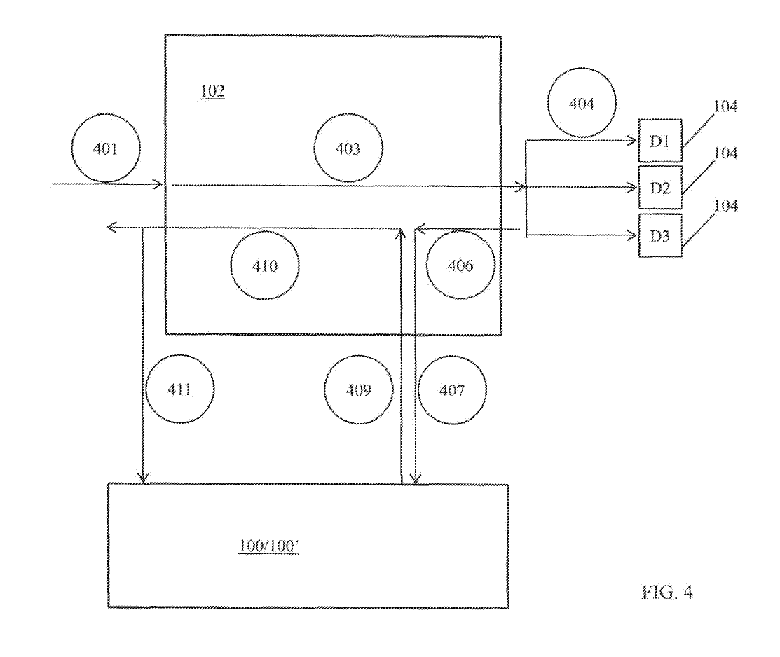

Reference is now made to FIGS. 3A and 3B which are simplified layouts of integration schema, constructed and operative in accordance with embodiments of the present invention. In FIG. 3A, the integration schema, for example, is implemented, by an Exchange, e.g. the platform 102 during e.g., RTB (Real Time Bidding) auction, or by other platforms such as a Header Bidding service, a SSP or Mediation platform. An ad request (content request or request) 301 may be issued to multiple demand partners (e.g., D1-D3) 104 via separate requests 302. Each request (or subrequest) 302 (from the request 301) may be customized as per the specific interface agreed between the sending and the receiving platforms e.g. may have additional parameters for this receiver.

In FIG. 3B, the receiving platforms, e.g., the demand partners D1-D3 104 respond 303 to the received request. The responses 303 may or may not include the actual informational content, e.g., ads. The platform 102, which is handling the informational content request, e.g., ad request 301, can collect all or part of the responses (e.g., only collect the responses with advertising inside) and may pass 305 this information along with ad request 301 to the system 100′, which awaits the response from the online flow described above about the ads' quality. Before the information is passed to the home server 100 and its system 100′. The platform 102 can further enrich 304 the information passed through, e.g., by resolving Internet protocol (IP) addresses to the actual geo location, exploring operating system and device model from the User-Agent header and similar. The data associated with the resolved IP addresses to the actual geo location, operating system and device model from the User-Agent header and similar, is known as request data, as this data is associated with the request, for example, from the requesting source 105 or the like. Alternatively, such an enrichment could be done before sending the requests 302 so they will carry additional information (also request data), which will be used by the selected demand partners D1-D3 104 to better adjust their offers to the actual inventory, device, e.g., source 105, and end user (of the device).

Alternatively, the platform 102 may implement the routine 305 to move data into a certain storage location, such as a log file, a database, or an external system, such as a messaging system (e.g., Apache Kafka). In such a case the routine 305 may deliver data to the entry point 201, as above described.

Reference is now made to FIG. 4, which is a diagram of an example architecture for testing the outgoing informational content, e.g., ads, constructed and operative in accordance with a embodiments of the present invention. The architecture is such that it allows the platform 102 to that intervene into the ads markup (e.g., Ad Exchanges) to verify the changes made by the systems of the ad exchanges. Typically, an entity, similar to that of the entity 402, may receive incoming traffic (an ad request (content request or request) 401 and may further process the request, e.g., by enriching data sent 404 to the demand partners D1-D3 104, for example, with geo location and device information (request data). When demand partners D1-D3 104 reply with their responses 406, the platform 102 may optionally call the system 100′. A real time option of such a call 407 is shown at FIG. 1C, and another option where data is sent to the system 100′ offline is shown at FIG. 2. Communication 407 and 409 with the system 100′ is optional for the platform 102, which may continue to build the final response 410 for the platform 102, which initiated the ad request 401.

During this process 410, the platform 102 may modify the advertising by adding or modifying parts in the ad markup. An example of such modification can be an addition of certain tracking pixels and/or code or code segments, which is supposed to report the platform 102 when a tracked event (e.g., an impression, a click) is created and is sent. Additional scenarios, such as those for video advertising, may require even more event notifications for the platform 102, for example, a first or second play event, first quadrant play event, and the like. With increasing complexity of the ads' code and growing number of features embedded in every platform 102, these ad markup modifications, introduced by the platform 102 during the ad flow handling may occasionally damage the advertisement while modifying it. An example of such damage could be that the modified ad will be unable to display, or that the impressions and/or the click tracking will work partially or not at all. This behavior results in monetary losses and potential damage to reputation and goodwill to all of the entities involved in the ad's delivery chain.

To reduce or avoid such damage, the platform 402 may report modified outgoing ads via an interface 411 to the system 100′. The system 100′, receives ads when all the modifications by the platform 102 are completed, will verify each add at least for its viewability, and for proper impressions and clicks tracking, ensuring that the advertisement is fully operational, like it was initially designed to operate in the destination environment (i.e., works as designed for the given device, operating system, web browser or an app, etc.) by the ad creators. The results of these verifications may be delivered back to platform 102 via the API 152 or in form of an online dashboard, as well as in form of periodic or real time reports that may be sent as per system-defined preferences (e.g., daily emails with summary reports and/or immediate alerts on damaged ads, etc).

Reference is now made to FIG. 5, flow diagram for the online flow, which is performed for example, automatically, and typically in real time. The flow diagram shows an exemplary method of real time information discovery. Entry point 501, which is also referred as entry point 103 (above), may be used by the platform 102 to access the online flow. Based on certain criteria for the informational content, for example in the form of an ad, such as ad content, the request or response parameters the system, described in the present invention may generate or otherwise assign a key 502, formed for example, of a unique identifier (ID) for the particular informational content, e.g., the ad or campaign. In addition to the unique ID, the key can also include request data, which can be used to search the database for a key corresponding to this informational content, i.e., advertisement. If the key 502 was found, the system 100′ may retrieve 506 the associated information from the database 160a and may return 507 this information to the calling platform. If the key 502 was not found, the system 100′ may initiate offline flow 504 and then return a response 505, informing the platform 102 that there is not any information available on this campaign/ad.

Reference is now made to FIG. 6, which is a flow diagram for processes performed by the explorer module 164b. The explorer module 164b, in addition to that described above, operates according to the logic illustrated at FIG. 6. Once a new message 601, for example, a built or modeled informational content, is received by the explorer module 164b, the module 164b attempts to explore the ad markup from that message and render it 602 according to the ad creative type (e.g. HTML banner, video clip or a native ad), so the ad will be displayed.

The explorer module 164b receives the built/modeled informational content, after it was analyzed by the media item analysis module 164a. The media item analysis module 164a uses the graphic (visual) data and text, including text data, of the informational content itself, as built/modeled from the original informational content, to categorize the informational content, as well as, for example, analyze the language and the actual content thereof for various meanings as well as against rules and policies (from the rules and policies module 154) for proper graphic and text content. These rules also include requirements for a privacy policy and links to destinations of certain categories and content, and also rules for being applied to the category of the informational content to determine whether the informational content should be blocked. This analysis may also assign a score to the informational content, in order to rate the informational content, and rank it, when compared to other informational content, and the like.

The explorer module 164b may operate multiple ads simultaneously (i.e., in different threads), and the system, described in the present invention may run multiple ads exploring modules to faster serve the incoming traffic. Once an informational content, e.g., an ad, is loaded 602, it may be examined for various errors 603. If errors are found, which meet internal decision criteria, the explorer module 164b may programmatically decide to not further process the ad, generating an error response 604. In this scenario, the error response 604 will be sent out 612 and the sub-unit (e.g., thread) of ads exploring module will switch to the next ad for processing.

If the ad was loaded absent any errors being detected, or if the explorer module 164b programmatically decided to ignore or keep aside the errors and continue with the current advertising, the requisite ad may be examined 605 for sending all impression tracking events to the respective destinations. This step 605 is optional, and may not be included in the typical preferred ads exploration flow. However, such a step 605 will be typically present in the ads testing flow described, for example, in FIG. 4.

When the previous operations are completed, the explorer module 164b analyzes this specific informational content, i.e., digital advertisement (advertisement), and emulates (e.g., virtually) a click 606. Such emulation assists in further exploring the information about the advertisement. Optionally, at the next step 607, the module 166b will verify the consistency of click tracking, and then will record the entire chain of redirection 608 (to the various web sites, web pages and the like, with their respective URLs), for example, in the virtual environment created by the system 100′, thus discovering all of the platforms that served this informational content, e.g., advertisement.

The last redirection in the chain may typically lead to the campaign landing page. The landing page (e.g., campaign landing page corresponding to the ad as part of an ad campaign) is for example, a web page, with a unique URL, The explorer module 164b typically gathers information 609 from the campaign landing page and may make it available, along with the information about analyzed informational content and redirection information for the further analysis by sending this information along with incoming data to other system modules, such as the Landing Page Domain Analysis module 166a and the Landing Page module 166b responsible for data analytics. Information, collected at the landing page may include, for example, the page title, the page body, images or video presented on the landing page, the advertising domain, page metadata such as keywords and description.

The data analytics performed by the landing page domain analysis module 166a, include, for example, determining the quality of the domain of the landing page, including its reputation, for example, via information from reputation services and/or by checking the domain of the landing page against whitelists/blacklists 166ax.

The data analysis performed by the landing page module 166b, collecting of information from each landing page itself, such as graphic (visual) information, text, and the data associated therewith, by the landing page information (info.) module 166b1. This landing page information is analyzed by the landing page analysis module 166b2, such that visual information, text, and data associated therewith, for example, for categories, context, content, and the like is analyzed for aspects such as being inappropriate for various classes of people, e.g., children, certain locations/geolocations, e.g., states, countries or regions. This analysis also includes, for example, visual/graphic and textual content and data associated therewith, of the landing page, against rules for the visual/graphic and textual content and data associated therewith for landing pages (as stored in the rules and policies module 154).

The explorer module 164b may collect any errors or other events 610 that happened during redirection chain or during the exploring of the landing page, e.g., a JavaScript pop-up alert message displayed on the page or a pop-up window opened while visiting the page or while following the chain of redirects. This information may be used for further campaign analytics, for example, a JavaScript alert pop-up message “Congratulations! You won $1,000,000!”, may be taking in account for campaign quality score analysis. Finally, the explorer module 164b typically generates an outgoing message 611 providing there all the explored information about an ad including any errors, popups, alerts and similar, a landing page and all the events that happened during ads handling, redirections if any, and landing page exploration. The message may be sent out 612 and the explorer module 164b may then handle a new advertisement as per the above described flow. The information, contained in such a message may be analyzed by other modules responsible of categorizing ads and campaigns, such as the Landing Page Domain Analysis module 166a and Landing Page module 166b, e.g., by running anti-scam, anti-virus and anti-spam algorithms, and the results may be added to the real time database 160a which is accessed in online flow of the information handling.

Reference is now made to FIG. 7, which is a diagram for real time mobile ad fraud detection and viewability verification, for the informational content, i.e., digital advertisement. A mobile device 105 (the source of an ad request) makes an ad request (advertisement content request) 713 to one or more advertisement platforms 714 (e.g., Mediation/Optimization platforms, SSPs, Ad Exchanges).

The requests 713 may be issued in the form of an auction when multiple requests 713 are simultaneously sent to the multiple platforms 714. Alternatively, the requests 713 can be issued to multiple platforms 714 one by one, each time one request to the next platform (so called “waterfall” method). Platform 102 (e.g., SSP, Exchange, Mediation or Optimization platform) which uses the system 100′, may either participate with one of the above described ad requesting methods along with platforms 714 directly receiving requests 713, or, as shown in FIG. 7, may receive requests 701 from one of platforms 714, thus acting as a demand partner for platform 714. Requests 701 may be identical or similar to the requests 713, or may be modified in a platform-specific way as per the implementation of platform 714. The platform 702 may optionally modify or enrich the request 703 and may send it to its demand partners via one of the delivery methods 704 (e.g., real time bidding (RTB) auction, waterfall).

Once the platform 102 makes a selection of the ad (advertisement content) to be returned 705 (e.g., as a winning bid in a RTB auction), it may optionally pass this ad 706 to the system 100′, which may add to the ad markup some fraud protection (e.g., JavaScript code, which access mobile device gyro and other sensors, and reports this information directly or indirectly to system 702), and returns the modified advertising (advertisement content) 709 back to the calling platform 102. The modified ad markup may be cached by either the system 100′ or the platform 102, and may be returned each time such an ad appears again as a selected choice in process 705. Furthermore, if the system 100′ uses the platform 102 for ad quality verification, such modified ads with various anti-fraud, tracking and viewability verifications enhancements may be prepared in advance during offline ad verification flow described above and illustrated in FIG. 6. Both a verified advertisement, which matches publishers brand protection policies, and an ad which was not verified for the ad quality may now carry fraud protection, tracking and viewability measurement code and tools.

Once such an ad reaches 715 the mobile device 105, the code added by system 100′, which, for example, records the ad environment (e.g., content next to which the ad is displayed, data from various device sensors such as gyro and more), and may make 719 this information to be available for system 100′. The system 100′, for example, analyzes the information and makes decisions about future impression opportunities for the given device, publisher, application, end user etc, e.g., if the device 105 was used by a person (user) 717 or it was just a software emulator running on a devices farm and used to fraudulently generate automatic impressions. For instance, the system 100′, for example, provides such analyzed information about incoming traffic quality if it was called by platforms 714, 102 while they verify incoming traffic 713, 701 respectively, thus saving the entire processing time and all the advertising costs associated with paying for the non-human traffic.

Additionally, a mobile application running on a mobile device 105 may use a mobile SDK (software development kit) 718 which may be an optional part of system 100′, of the present invention. Such a SDK 718, or just a functional part of it (i.e., source code, routines) may be included in other SDKs, such as monetization/advertising SDK provided by any of the platforms 714, 102, or developed by the mobile publisher or by a third party. The mobile SDK 718 and/or its routines acting as a part of another SDK or directly in a mobile application can be used for strict verification of mobile impression quality, fraud protection and viewability verification.

For instance, according to the application's permissions, the SDK 718 may from time to time activate a camera on the mobile device 105 and analyze the received video stream, e.g., by deploying various face recognition algorithms to verify that there is a real person 717 who is indeed interacts 716 with the mobile device 105. The SDK 718 may pass information 719 to system 100′, either informing it about analytics results or passing raw information for the analysis. The system 100′ may use the results of the analysis for fraud determination if it is involved in handling requests 713, 701 as above described.

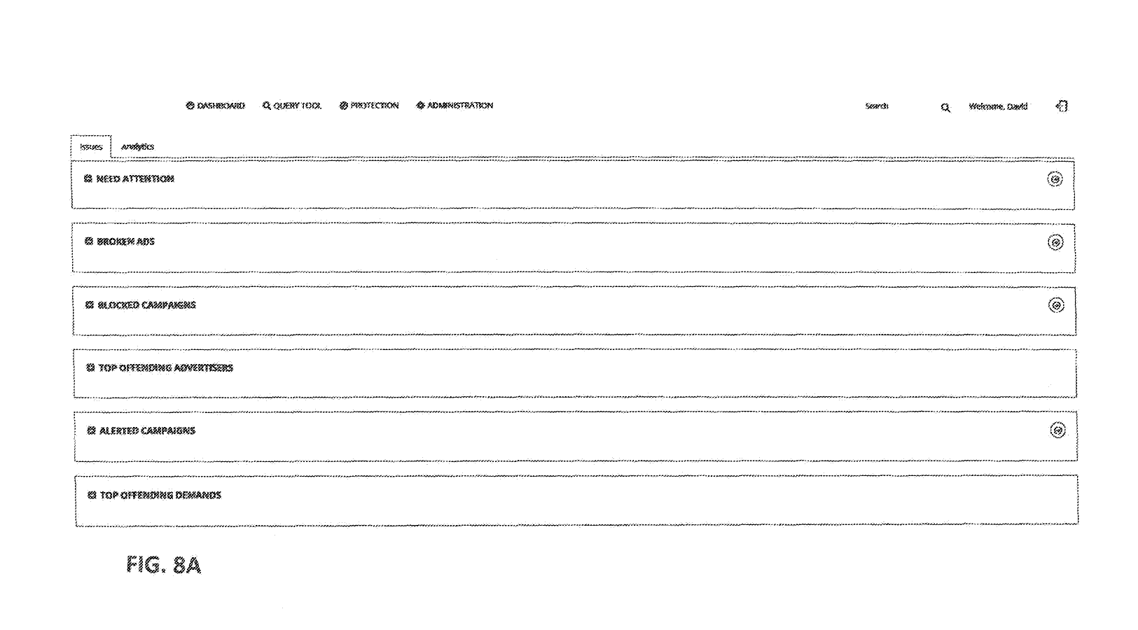

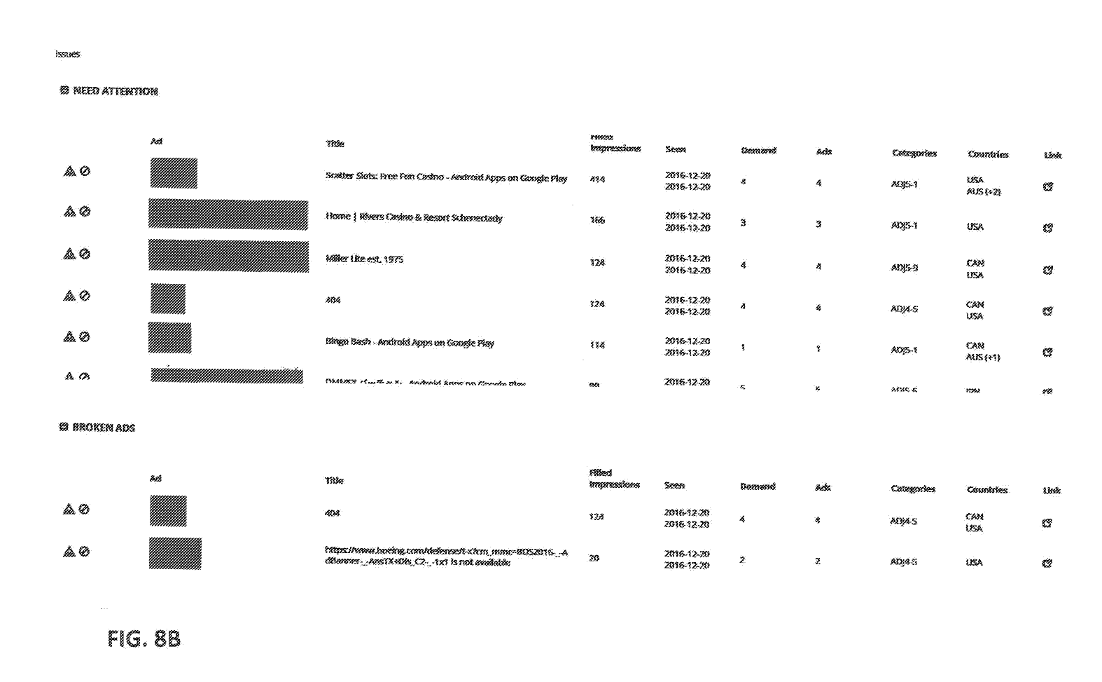

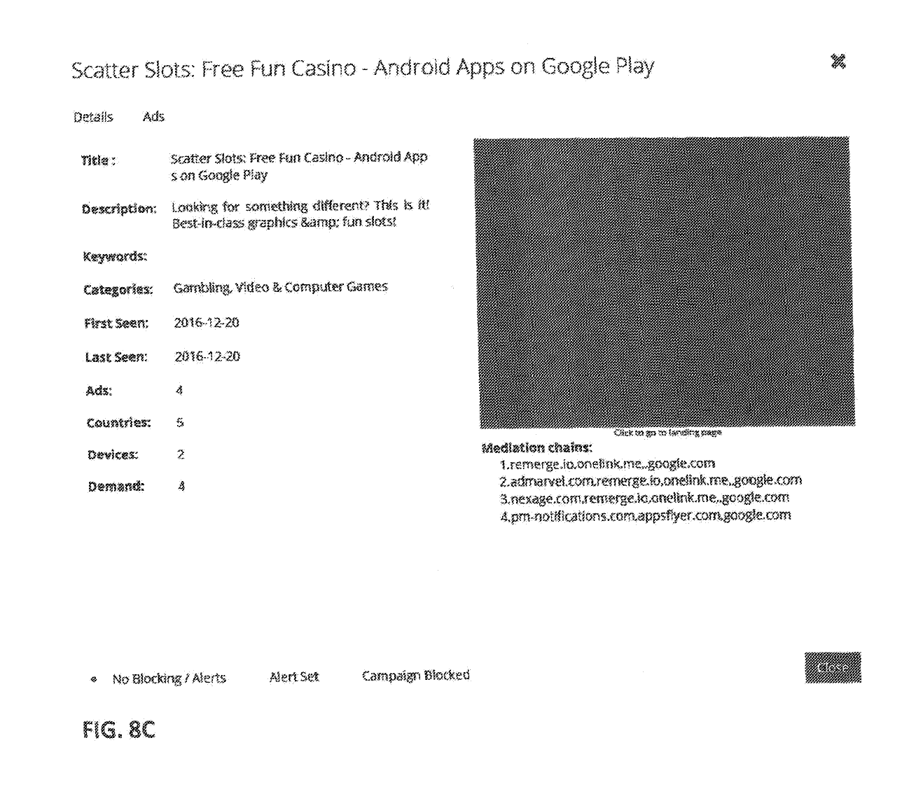

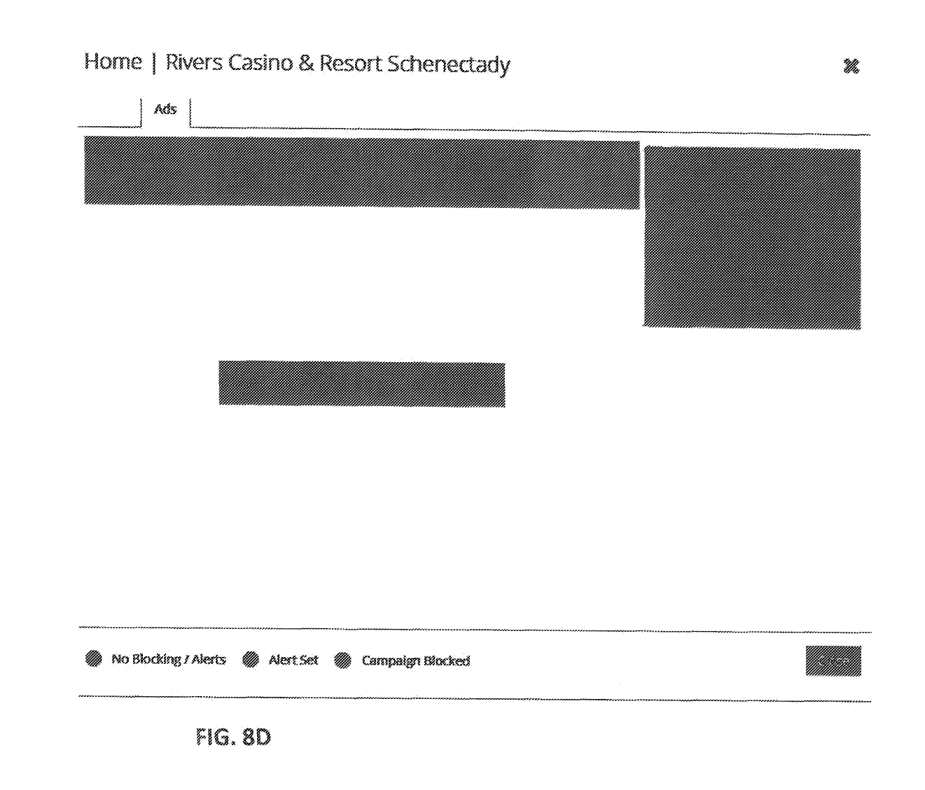

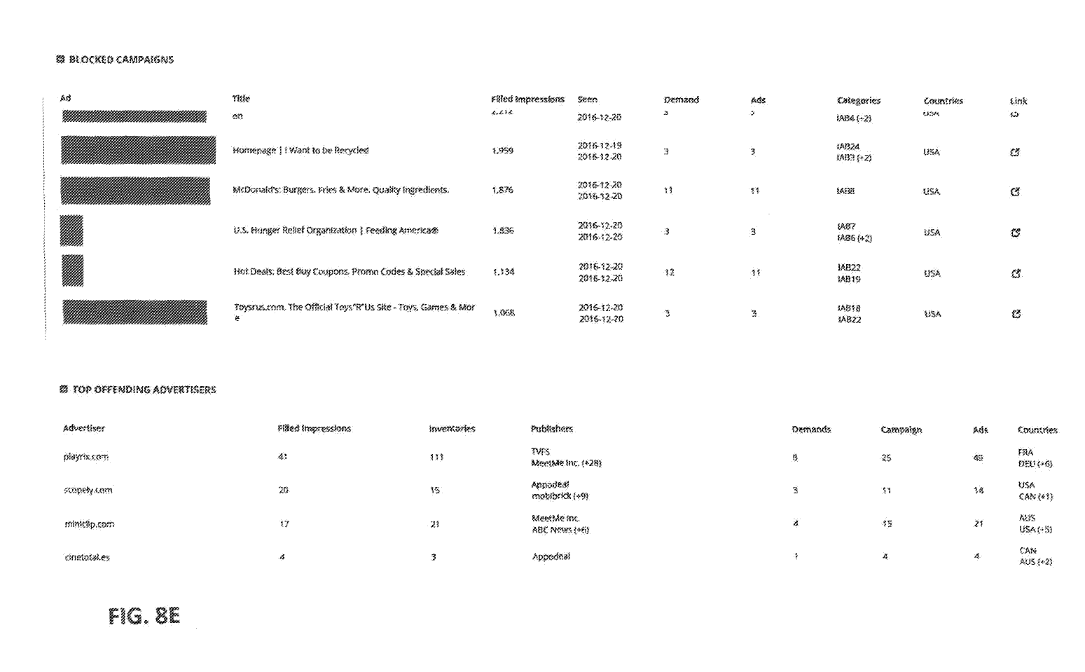

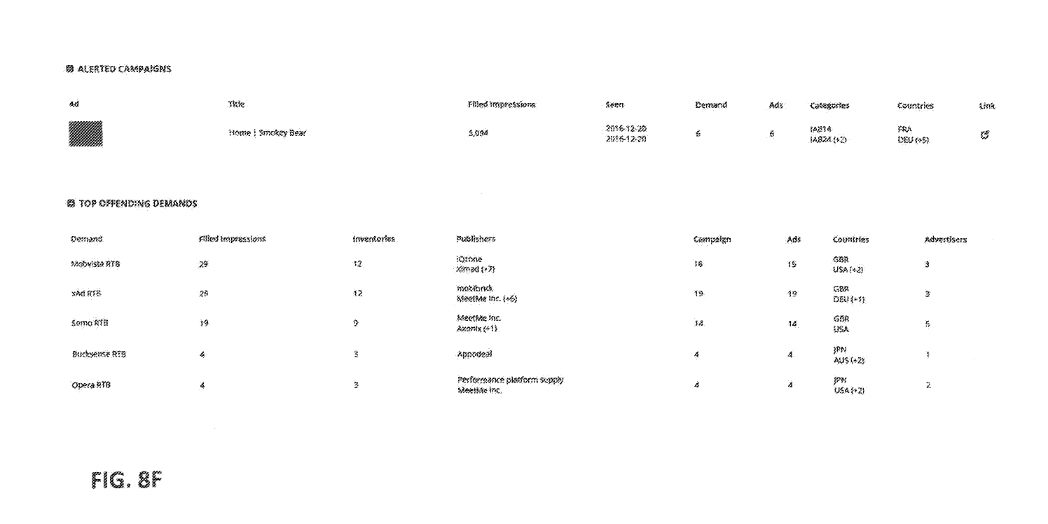

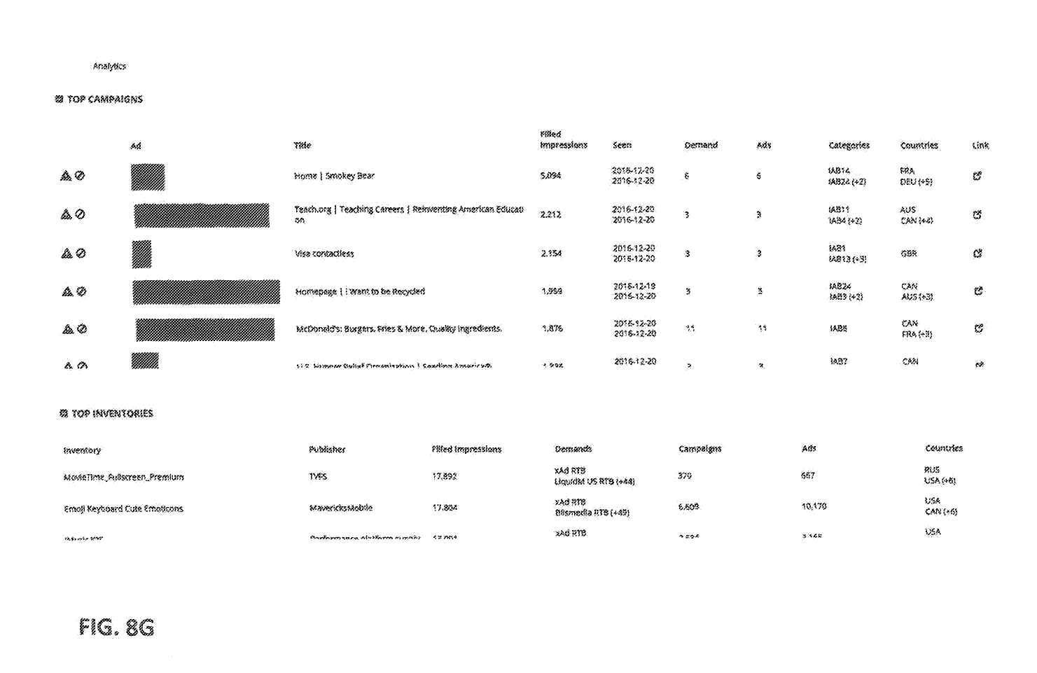

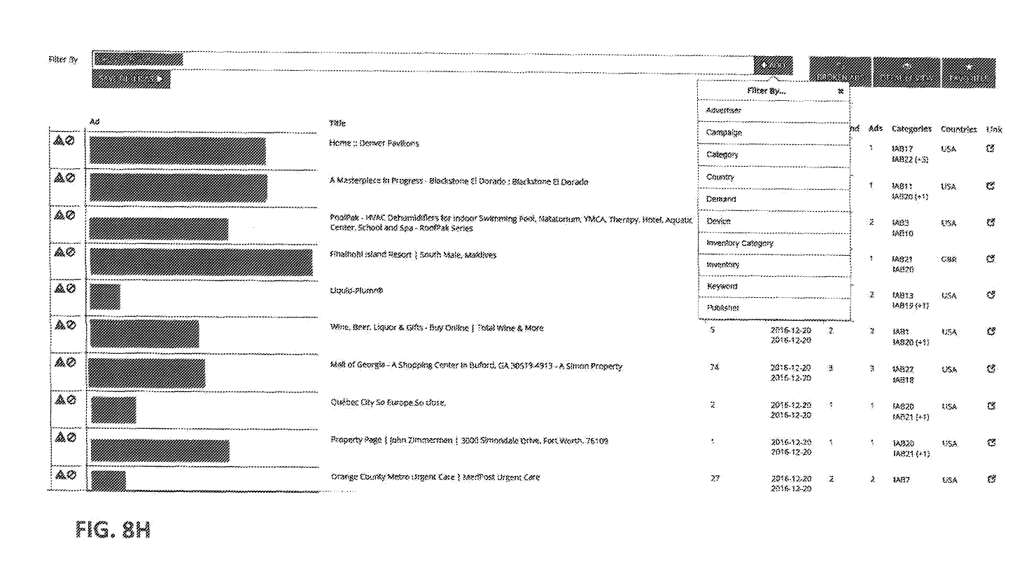

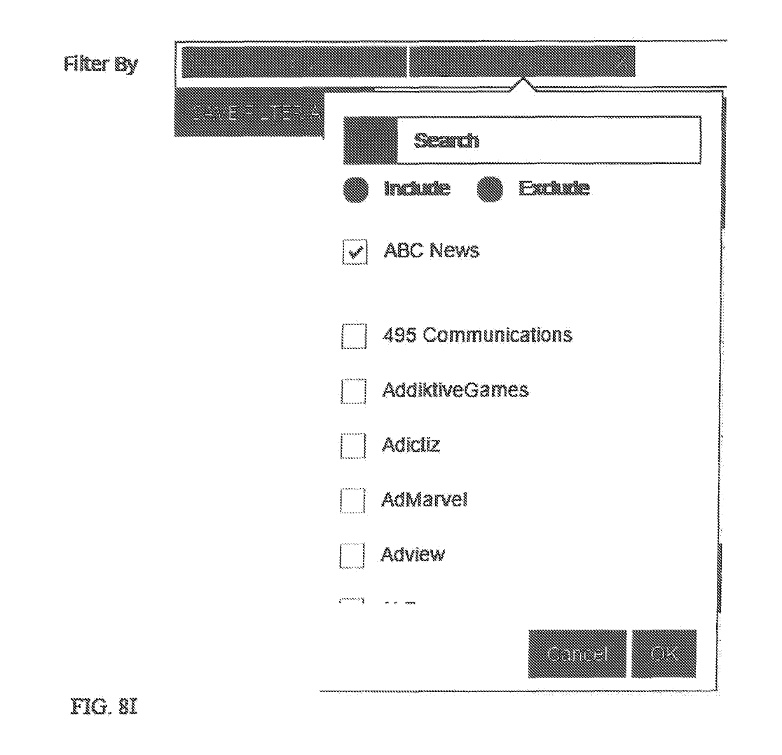

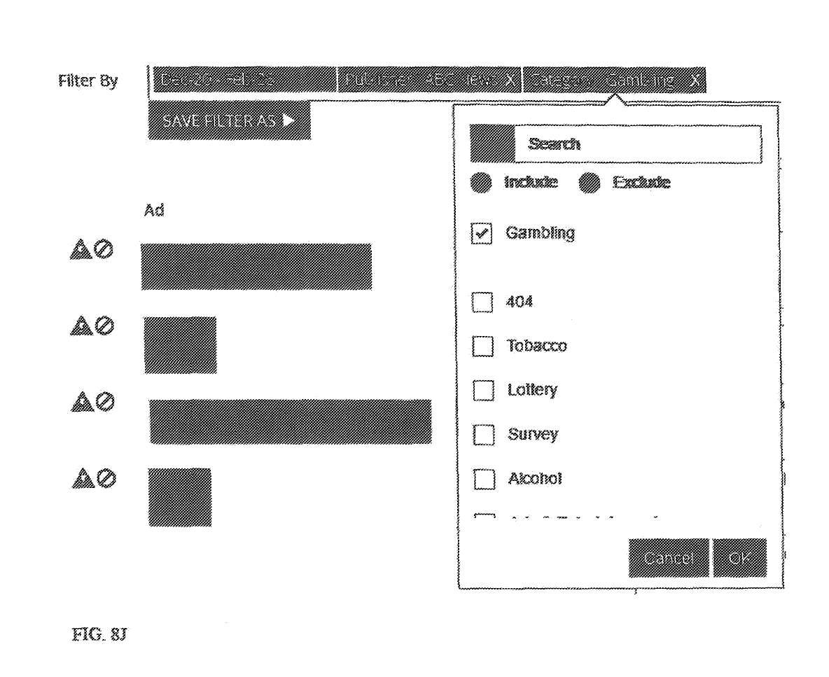

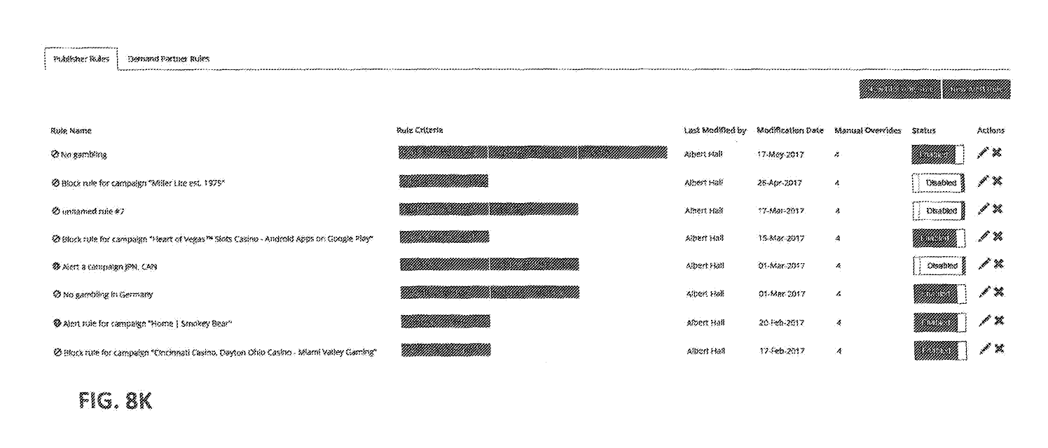

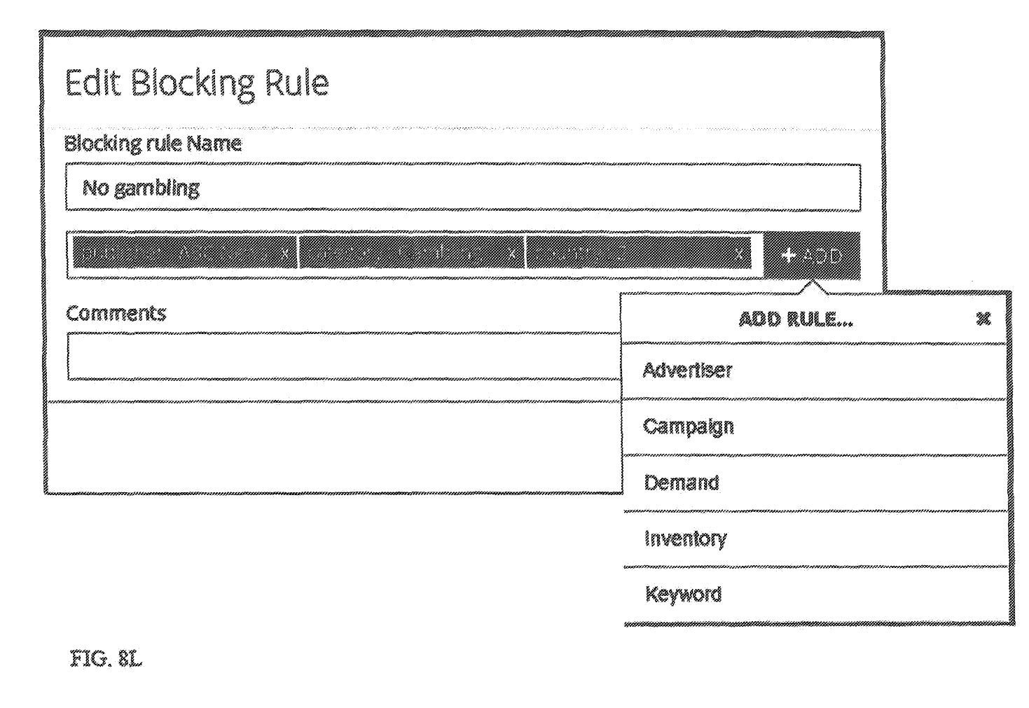

Reference is now made to the screen diagrams of FIGS. 8A-8L. These screen diagrams represent various points of view (POV) to the data that may be collected by the system 100′, described in the present invention, namely a POV of an Ad Exchange, which can see all of its publishers' inventory and all of the demand data. Other participants in the ads ecosystem scene may have different graphic representation of the data, collected, handled and analyzed, and represented by the system 100′.

The screen diagram of FIG. 8A is an exemplary representation of a dashboard for the system operator, e.g. a Publisher or an Account Manager within an Ad Network or Ad Exchange. The dashboard is composed of multiple visual tables, where each table represents a certain group of interests for the ad campaigns analyzed by the present invention.

The screen diagram of FIG. 8B represents a dashboard view with a few opened tables, where each table shows a certain group of analyzed campaigns along with information for each campaign. Every campaign is represented as a single table row and the operator of GUI can take multiple actions on each campaign. e.g. can add an alert (using alert icon on the left in each campaign' row) or can block certain campaign (using “block” icon on the left). Each row carries additional information about the campaign, including first- and last-seen dates, number of impressions where this campaign was shown, number of demand partners that send this campaign out, number of ads that belong to this campaign, detected campaign' categories, countries where this campaign was served, link to the campaign' landing page and a visual representation of a campaign creative.

The screen diagram of FIG. 8C represents an informational window which displays detailed information about certain advertising campaign, including, for example, title, description, keywords, categories, first-seen and last-seen dates, number of ads that represent this campaign, number of countries where it runs, number of different devices that got this campaign, number of demand partners who send this campaign out, an image of the campaign' landing page with the link with leads to the actual campaign' landing page URL, list of various mediation chains discovered by the present invention during multiple validations of this campaign, action buttons that allow to set or unset an alert or block or unblock this campaign.

The screen diagram of FIG. 8D is a part of the informational window described in FIG. 8C and represents the ads that belong to the same advertising campaign.

The screen diagram of FIG. 8E shows multiple campaigns' tables from the dashboard, specifically “Top Offending Advertisers” table where an operator can review the advertisers that deliver improper ads and can block all or some of them so all their campaigns will be marked as “blocked”, and will be filtered out in the real time flow.

The screen diagram of FIG. 8F shows a “Top Offending Domains” table where an operator can review and possibly block a demand partner who sends him too much offensive material, in informational (e.g., advertisement) content.

The screen diagram of FIG. 8G shows analytical part of the dashboard where campaign information is visualized according to campaigns statistics.

The screen diagram of FIG. 8H shows query mode of the present invention where an operator can select a set of filters and apply them to the system, displaying only campaigns that match her criteria, defined in the filters. This includes selection by date, by publisher, by keyword, inventory, device, demand partner, country, category, campaign and advertiser, where each filter can carry multiple values (e.g. multiple countries can be selected in one filter at once). This way an operator can review only the set of campaigns of her interest, e.g. campaigns that run today in a certain application when the requests come from China and the device is and Android phone e.g. Samsung® S8™.

The screen diagrams of FIG. 8I and FIG. 8J show multiple selections for a query filter as described above for FIG. 8H.

The screen diagram of FIG. 8K shows protection rules that an operator of the present invention can define in the system 100′ in the rules and policies module 154, for preemptively protecting digital inventories from unwanted ads. For instance, one can define that a certain inventory, like informational content for children, who should never get alcohol or tobacco campaigns. Another rule can disallow, for example, gambling campaigns for certain locations, for example, China.

The screen diagram of FIG. 8L shows the creation of above described protection rule as per the description for FIG. 8K. An operator can apply multiple filters to his rule, creating a well-tuned set of definitions, so only specific campaigns in specific inventories or locations will be blocked by such a rule.

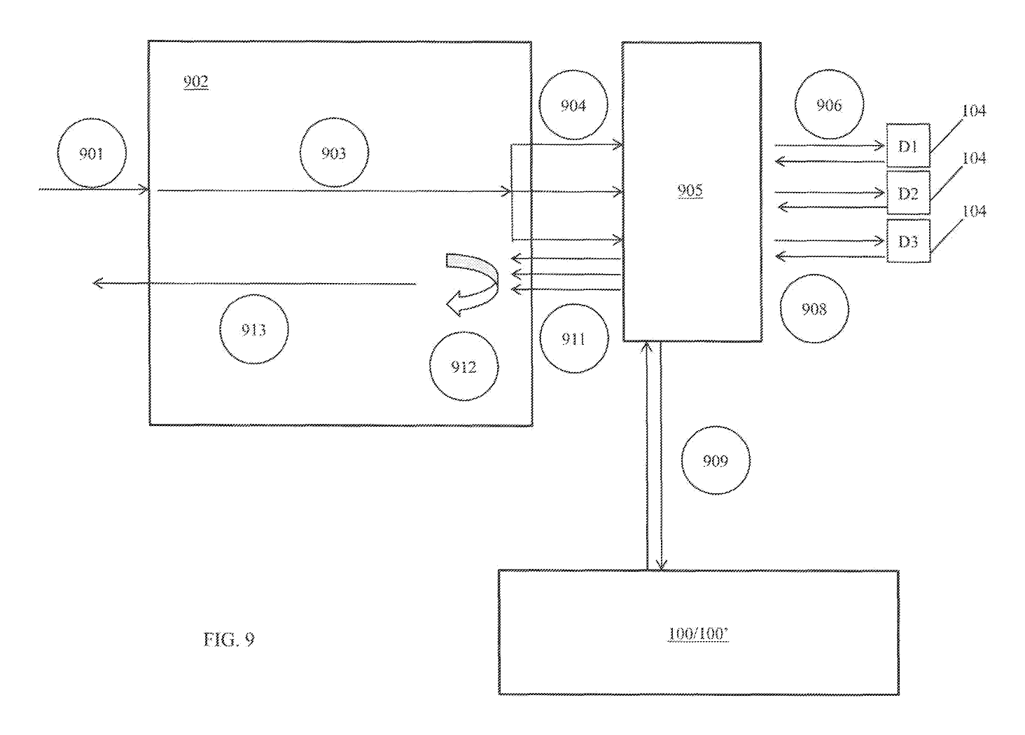

Reference is now made to FIG. 9, which is a diagram of a real time advertisement categorization and validation system using a proxy in accordance with embodiments of the present invention. The incoming content request (informational content request), e.g., ad request, 901 is served by an entity, such as a platform 902 (e.g., SSP, Ad Exchange), similar to the platform 102 detailed above. This entity 902 may enrich 903 the ad request 901, for example, by adding information about the device, for example, device 105 (FIG. 1A) which receives the informational content, e.g., the ad (e.g., and the device's 105 operating system, geo location, and similar), and may send the results 904 to multiple demand partners D1-D3 104, for instance via a RTB auction bid requests. The home server/system 100/100′, is, for example, integrated with a network proxy 905, such as NGINX, an open-source proxy server, available from NGINX, Inc. of San Francisco, Calif. (https://www.nginx.com). A software module communicating with network proxy 905, for example a plugin module for NGINX, transfers 909 the information related to requests 904 and responses 908 to the system 100′. The system 100′ analyzes the information, and, for example, returns the results 911 back to proxy 905. The results 911, for example, contain the information about ad quality and matching criteria for the publisher-defined brand policies criteria. The proxy 905 may add information received from system 100′ to its responses while delivering information back to the calling platform 902, for example, as additional HTTP headers added to each response 911, or by modifying the responses 908 to include this information. The calling platform 902 may analyze the proxy responses 911 in the routine 912 (for example, a procedure for selecting a winning bid in a RTB auction), including the information received from system 100′, for example, consider this information while creating the final selection of the ad to be delivered 913.

Reference is now made to FIG. 10, which is a simplified diagram of an example advertising ecosystem in accordance with embodiments of the present invention. A user 1001 communicates with the advertising ecosystem 1005-1012 by multiple electronic devices, including the source 105 (FIG. 1), for example, such as mobile devices, including smart phones 105a tablets, iPads®, computers 105b and television sets 105c. The devices 105a-105c access content consumed by users, represented, for example, by the user 1001 (e.g., a web site, a mobile application or a TV program), while the advertisers 1010 are willing to advertise products and services with or without the relation to such content or such a user. The content to be consumed by users 1001 is typically provided by Publishers, represented by the publisher at server 106, who, for instance, are the owners of a web site or a mobile application. The Publishers 106 are typically paid for their digital properties (web sites, mobile and desktop applications and similar), and therefore, they may accept informational content, including, for example, advertisements to appear along other content while using their digital properties. The informational content is typically within locations or spots within the publisher's content (as discussed above).

The advertising flow is started by an ad request 1013, representing an impression opportunity, issued by software running on behalf of the Publisher 106 and within the publisher's digital properties, such as JavaScript running on a web page of the Publisher 106 or a SDK (Software Development Kit) used in their mobile application. In some cases, for example in a header bidding auction, a Publisher 106 may issue multiple simultaneous requests 1013 to multiple advertising platforms 1005 and may compare the results, selecting the best advertising. Typically, a Publisher 106 may select an ad with the highest price. Using the system 100′, the Publisher 106 or entity 1005-1009 acting on behalf of the Publisher, may consult with the system 100′ which ad has the best fit as per the Publisher-defined criteria and can make a programmatic decision to select the best matching ad and not the highest-paying ad. Thus Publishers 106 can receive campaigns that better match their audiences and their brand protection policies.

Optionally, the publishers 106 may develop and operate their own mediation platforms 1005 (for instance the above mentioned header bidding auction mechanism), or they may use one of the existing mediation/optimization platforms, such as Heyzapp (https://www.heyzap.com/mediation).

The mediation platform 1005 may optionally work with one or more SSP (Supply Side Platform) 1006 that, in turn may optionally work with one or many Ad Exchanges 1007, such as a Publisher Side Mediation Platform, which can be server or client based. The Ad Exchange 1007 works with multiple DSPs (Demand Side Partners) and/or Ad Networks 1008, sending those impressions opportunities that represent ad request 1013 and receiving back the advertisement. DSPs and Ad Networks 1008 typically work with multiple Advertising Agencies and Trade Desks 1009 who manage the advertising campaigns for advertisers 1010.

The system 100′ can be used, for example, by multiple systems 1005, 1006 and 1007 that are relatively close to the Publisher 106 in the ad delivery flow 1013. The system 100′ may, for example, be integrated with mediation platforms 1005, SSPs 1006 and/or Exchanges 1007. It may be optionally used by DSPs and Ad Networks 1008 that are interested to verify their advertising quality, visualize media and inventory they buy or use collected data for their business purposes.

Any of the above mentioned entities 1005-1009 and their relationships are optional. Additionally, a mediation platform 1005 can work directly with multiple Exchanges 1007 and/or DSP and Ad Networks 1008.

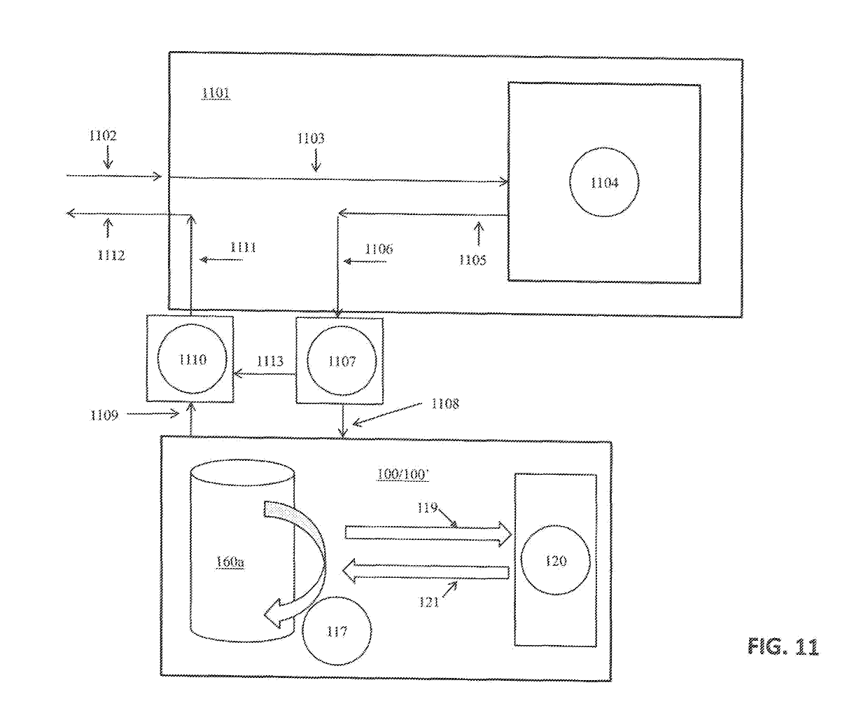

Reference is now made to FIG. 11, which is a diagram of an example ad traffic validation process, by the communication network 50 (FIG. 1A) or by an Internet service provider (ISP). A communication network provider 1101 such a network operator, including mobile networks (e.g., Verizon. AT&T) or an ISP operating on either its own or a third party network infrastructure, can use the system 100′ to filter out improper informational content, including advertisements intended to be delivered to their end users/subscribers.

The network provider 1101 receives multiple HTTP requests 1102 initiated by user devices 105a-105c (FIG. 10) that use mobile applications, browse web sites or view television broadcasts. Network provider 1101 is acting as a gateway, forwarding 1103 these requests to their destination 1104, typically a web service, which provides requested information 1105 back to the caller. Once an HTTP response 1105 is received by the network provider 1101, it is transmitted 1106 to the filtration module 1107, which passes only HTTP responses containing portions of informational content, for example, portions of the advertisement (advertisement content), such as creatives, advertising landing pages and, optionally, information received in redirection chains.

The filtration module 1107 transmits 1108 the aforementioned portions of the informational content, e.g., advertisement content for the advertisement, to the system 100′ to be categorized and validated in real time. Optionally, the filtration module 1107 passes 1113 response information to a modifier module 1110 to being kept upon Modifier 1110 receives the information 1109 from system 100′. This optional step 1113 may be needed to preserve the original response 1105 (e.g., in its digital form as an unmodified set of bytes) so it can be properly changed by modifier module 1110, if required, when it receives information 1109 from the system 100′. The validation process started by delivering 1108 informational content, e.g., advertisement content, is in accordance with that for the homer server/system 100/100′ of FIG. 1A and detailed above. The system 100/100′ responds with information 1109, such as metadata, regarding provided informational content, e.g., advertisement content, 1108.

This information 1109 is analyzed by the modifier module 1110, to determine whether the informational content, e.g., advertisement content, should be modified. The modifier module 1110 decides whether the original content of the response 1105 (typically, a HTTP response) should be modified. An example of such a modification decision, by the modifier module 1110 is, a situation when the system 100′ detects a virus or malware inside the response 1105, or in links that are presented on the web page, which is compiled from one or more responses like 1105. In such a case, the modifier module 1110 may decide to either completely cut off improper content from the original response 1105, or replace the improper content with other pre-validated informational content. Optionally, the modifier module 1110 can contact its advertising partners, e.g., demand partners, like Ad Networks or Ad Exchanges, requesting them to supply replacement informational content, such as a new ad (advertising content) from a trusted and validated partner.

The modifier module 1110 delivers 1111 the optionally modified response 1105 back to Network Provider 1101, who in turn returns 1112 the optionally modified response to the caller. The response 1112 carries validated informational content, or is without any content.

Additionally, the system 100′ can be tuned (adjusted) by a network operator 1101 to make real time decisions about removal or replacement of different type of information content, e.g., advertisement content, according to various parameters, such as publisher preferences and brand protection policies. This tuning or adjustment is performed via a GUI, such as the GUI shown in FIGS. 8A-8L. For example, a publisher who runs an online casino web site for adults audience may allow Gambling informational content such as ads to appear on its web site, while another publisher who operates a mobile gaming application for teenagers will request that the network provider 1101 remove or replace any gambling informational content, e.g., advertisement content or ads, that are inappropriate for its audience and/or from its digital inventory (of advertisement content).

The embodiment is such that the system 100′ along with the filtration module 1107 and modifier module 1110, shown at FIG. 11, is shown separately from the network provider 1101 infrastructure, for illustration purposes only. This embodiment can be installed as a part of the network provider 1101 infrastructure, including installation at multiple entry points and, optionally, similar to a firewall installation with one or multiple nodes. Optionally, the embodiment can be installed separately, either on premises or remotely, e.g. in the cloud such as AWS (Amazon® Web Services) or Google® Cloud.

It will be apparent to those skilled in the art that various modifications and variations can be made to various embodiments described herein without departing from the spirit or scope of the teaching herein. Thus, it is intended that various embodiments cover other modifications and variations of various embodiments within the scope of the present teachings.

The implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A method for verifying informational content comprising:
receiving informational content;
assigning a key including a unique identifier for the informational content; and,
determining whether the key for the informational content exists; and,
if the key exists, transmitting data associated with the informational content to a first predetermined destination; and,
if the key does not exist, analyzing the informational content in a virtual environment to determine characteristics of the informational content, before transmitting the data associated with the informational content to a second predetermined destination.

2. The method of claim 1, wherein the first predetermined destination and the second predetermined destination are the same destination.

3. The method of claim 1, wherein the first predetermined destination and the second predetermined destination are different destinations.

4. The method of claim 1, wherein the key additionally includes data associated with a request for the informational content from a source over a communications network.

5. The method of claim 2, wherein the data associated with the informational content includes metadata, and the first and second predetermined destinations include a computerized platform.

6. The method of claim 5, wherein the computerized platform functions as an exchange.

7. The method of claim 6, wherein the receiving the informational content includes receiving a plurality of informational content in response to a request for at least one informational content from a source, each of the informational content received from a demand partner over the communications network, and the computerized platform analyzing the metadata associated with each of the visual items to select at least one of the informational contents to satisfy the request for at least one informational content from the source.

8. The method of claim 4, wherein the determining whether the key for the informational content exists includes comparing the key to at least one key in a storage media for a correspondence including matching keys.

9. The method of claim 1, wherein the analyzing the informational content in a virtual environment to determine characteristics of the informational content includes building the informational content and modeling the built informational content.

10. The method of claim 9, wherein the modeling the built informational content includes:
analyzing the built informational content;
analyzing a click path from the built informational content to a landing page of a destination;
analyzing the landing page; and,
analyzing the domain of the landing page.

11. The method of claim 10, wherein the modeling the built informational content additionally comprises:
assigning a score to the informational content.

12. The method of claim 10, wherein analyzing the built informational content includes: determining a category for the informational content from the visual and textual content of the informational content; and, analyzing the visual and textual content of the built informational content against rules for the textual and visual content for informational content.

13. The method of claim 12, wherein the rules include requirements for at least a privacy policy and links to destinations of certain categories and content.

14. The method of claim 13, additionally comprising: applying at least one rule to the category to determine whether the informational content should be blocked.

15. The method of claim 10, wherein analyzing the click path includes verifying that all links are operable and direct to existing destinations web pages which are valid.

16. The method of claim 10, wherein analyzing the landing page includes:
determining a category for the informational content from the visual and textual content of the landing page; and,
analyzing the visual and textual content of the landing page against rules for the textual and visual content.

17. The method of claim 10, wherein analyzing the domain of the landing page includes at least one of:
determining whether the domain is on a whitelist or a blacklist; and,
determining the quality of the domain including basing the quality on a reputation of the domain.

18. The method of claim 1, wherein the informational content includes at least one of: a creative, a banner, and an electronic graphic, which is click linked to a destination along the communications network.

19. The method of claim 4, wherein the request data includes one or more of source location, source operating system, and source device type.

20. The method of claim 1, wherein the informational content includes visual media items, which include one or more of: graphics, text, and click links.

21. The method of claim 20, wherein the visual media items include one or more of: banners, creatives, pop overs, pop behinds, scrolls, and video clips.

22. The method of claim 1, wherein receiving the informational content includes: receiving the informational content as filtered from a Hypertext Transfer Protocol (HTTP) response to an HTTP request.

23. A system for verifying informational content comprising:
a storage medium for storing computer components; and,
a processor for executing the computer components comprising:
a first computer component configured to assign a key including a unique identifier for the informational content; and,
a second computer component configured to determine whether the key for the informational content exists; and,
if the key exists, transmitting data associated with the informational content to a first predetermined destination; and,
if the key does not exist, analyzing the informational content in a virtual environment to determine characteristics of the informational content, before transmitting the data associated with the informational content to a second predetermined destination.

24. The system of claim 23, additionally comprising: a third computer component configured to determine whether the key for the informational content exists, by comparing the key to at least one key in a storage media for a correspondence including matching keys.

25. The system of claim 23, additionally comprising: a fourth computer component configured to build the informational content and modeling the built informational content, for analyzing the informational content in the virtual environment.

26. The system of claim method of claim 25, wherein the modeling of the built informational content includes:
analyzing the built informational content;
analyzing a click path from the built informational content to a landing page of a destination;
analyzing the landing page; and,
analyzing the domain of the landing page.

27. The system of claim 26, wherein the modeling the built informational content additionally comprises:
assigning a score to the informational content.

28. The system of claim 25, additionally comprising: a fifth computer component configured for analyzing the built informational content by processes including:
determining a category for the informational content from the visual and textual content of the informational content; and,
analyzing the visual and textual content of the built informational content against rules for the textual and visual content for informational content.

29. The system of claim 28, wherein the rules include requirements for at least a privacy policy and links to destinations of certain categories and content.

30. The system of claim 29, wherein the fifth computer component is additionally configured to: apply at least one rule to the category to determine whether the informational content should be blocked.

31. The system of claim 26, additionally comprising: an explorer module in communication with the second computer component, the explorer module configured to analyze the click path, including verifying that all links are operable and direct to existing destination web pages which are valid.

32. The system of claim 26, additionally comprising a landing page module in communication with the second computer component configured to:
determine a category for the informational content from the visual and textual content of the landing page; and,
analyze the visual and textual content of the landing page against rules for the textual and visual content.

33. The system of claim 26, additionally comprising a landing page domain analysis module in communication with the second computer component configured to:
analyze the domain of the landing page by at least one of:
determining whether the domain is on a whitelist or a blacklist; and,
determining the quality of the domain based on a reputation of the domain.

34. The system of claim 23, additionally comprising:
a filtration module in communication with the first computer component, the filtration module configured for: filtering the informational content from a Hypertext Transfer Protocol (HTTP) response to an HTTP request, and transmitting the informational content as filtered to the first computer component.

35. A computer usable non-transitory storage medium having a computer program embodied thereon for causing a suitable programmed system to verify informational content, by performing the following steps when such program is executed on the system, the steps comprising:
receiving informational content;
assigning a key including a unique identifier for the informational content; and,
determining whether the key for the informational content exists; and,
if the key exists, transmitting data associated with the informational content to a first predetermined destination; and,
if the key does not exist, analyzing the informational content in a virtual environment to determine characteristics of the informational content, before transmitting the data associated with the informational content to a second predetermined destination.

36. The computer usable non-transitory storage medium of claim 35, wherein the key additionally includes data associated with a request for the informational content from a source over a communications network.

37. The computer usable non-transitory storage medium of claim 36, wherein the informational content includes at least one of: a creative, a banner, and an electronic graphic, which is click linked to a destination along the communications network.

38. The computer usable non-transitory storage medium of claim 36, wherein the request data includes one or more of source location, source operating system, and source device type.

39. The computer usable non-transitory storage medium of claim 35, wherein the informational content includes visual media items, which include one or more of: graphics, text, and click links.

40. The computer usable non-transitory storage medium 39, wherein the visual media items include one or more of: banners, creatives, pop overs, pop behinds, scrolls, and video clips.
